(19) United States
(12) Patent Application Publication
(10) Pub. No.: US 2012/0198091 A1
(43) Pub. Date: Aug. 2, 2012

(54) NETWORK SYSTEM, CONTROL APPARATUS AND NETWORK APPARATUS

(75) Inventors: Yasushi KANADA, Tokyo (JP); Yasushi KASUGAI, Ninomiya (JP)

(73) Assignee: HITACHI, LTD., Tokyo (JP)

(21) Appl. No.: 13/225,598

(22) Filed: Sep. 6, 2011

(30) Foreign Application Priority Data
Jan. 28, 2011 (JP) 2011-016728

(51) Int. Cl. G06F 15/173

(52) U.S. Cl. 709/238

(57) ABSTRACT

It is provided a network system comprising a plurality of computers and a control apparatus coupled to the plurality of computers via a plurality of network apparatuses. The control apparatus holds a plurality of first addresses and conversion rules for converting each of the plurality of first addresses into a second address, extracts one of the plurality of first addresses and one of the conversion rules when requested by one of the plurality of computers, and transmits the extracted one of the plurality of first addresses and the extracted one of the conversion rules to the one of the plurality of computers that has issued the request. The one of the plurality of computers that has issued the request converts the one of the plurality of first addresses into the second address by using received conversion rule, and holds the converted second address.

### CLAIM OF PRIORITY

The present application claims priority from Japanese patent application JP 2011-016728 filed on Jan. 28, 2011, the content of which is hereby incorporated by reference into this application.

### BACKGROUND OF THE INVENTION

This invention relates to a network system, and more particularly, to a network system that transmits/receives a packet containing a destination address and a source address.

In packet communication, packets can be communicated without following a physical network protocol by using a logical network protocol separate from the physical network protocol.

In order to communicate packets in a system that uses such a two-layer protocol (i.e., a physical protocol and a logical protocol), a sender address and a receiver address need to be specified for each of the two protocol layers, and the specified addresses further need to be associated between the two protocol layers. Specifically, a sender address specified for one protocol layer needs to be associated with a sender address specified for the other protocol layer, and a receiver address specified for one protocol layer needs to be associated with a receiver address specified for the other protocol layer.

IP over Ethernet (Ethernet is a registered trademark and this applies throughout the specification) can be given as a first example of communication technology that uses a two-layer or multilayer protocol.

With IP, which stands for Internet Protocol, worldwide communication is nowadays a common practice and IP is implemented on various physical networks. One of IP variations that are implemented on a physical network is IP over Ethernet.

Each host computer that uses IP over Ethernet holds an Address Resolution Protocol (ARP) table, which shows an association relation between a logical network address in a segment and a physical network address, in order to implement IP over Ethernet. The ARP table stores a logical network address in a segment, namely, an IP address, in association with a physical network address, namely, a Media Access Control (MAC) address on a one-on-one basis.

When a host computer in a communication system that uses IP over Ethernet communicates to/from a host computer whose address is not stored in the ARP table, an ARP message for synchronizing ARP tables needs to be broadcast (in the case of IPv4) or multicast (in the case of IPv6) prior to the communication. A method of associating an address with the use of an ARP message has been proposed in RFC 826, An Ethernet Address Resolution Protocol—or—Converting Network Protocol Addresses to 48.bit Ethernet Address for Transmission on Ethernet Hardware, IETF.

A second example of the communication technology that uses a two-layer protocol is Wide Area Ethernet communication technology by MAC-in-MAC.

A host computer that uses Wide Area Ethernet communication communicates over Ethernet with the use of an Ethernet protocol. When the used protocol is a two-layer protocol, communication in the lower layer, namely, wide area communication, is free from network restrictions of the upper layer. In other words, with a two-layer protocol, Ethernet's drawback of low scalability is lessened. Communication technology by MAC-in-MAC has been proposed in, for example, JP 2002-344476 A.

JP 2002-344476 A proposes a method of communicating packets between two local area networks (LANs) that are coupled by a wide area network (WAN) implemented with the use of VLAN technology.

In the proposed method, if a switch that is disposed at the entrance to the WAN from one of the LANs holds an address or other types of information for identifying a switch that is disposed at the exit from the WAN and connected to the other LAN, the switch disposed at the entrance transfers a packet adapted for a two-layer protocol only to the switch at the exit. On the other hand, if the switch disposed at the entrance does not hold an address or other types of information for identifying the switch disposed at the exit, the switch at the entrance broadcasts a packet to every switch in the VLAN that might be the exit.

In this case, an address associated with the upper protocol layer of the two-layer protocol is an address unique to each host computer. A lower address associated with the upper-layer address is the address of a WAN switch.

If the address association relations that are held in the respective switches are not thorough, the switches need to broadcast a packet. In short, packet broadcasting for associating addresses for two layers with each other is necessary also in MAC-in-MAC.

### SUMMARY OF THE INVENTION

As described above, a host computer in a system that uses IP over Ethernet proposed in RFC 826 needs to send an ARP message by broadcast or multicast in order to associate addresses for two protocol layers with each other. This gives rise to the following two problems:

The first problem is an increase in network load caused by the transmission of an ARP message. Specifically, the address association relation of a newly introduced host computer, or the address association relation of a host computer that has not been communicating for a while but is about to resume communication, is not stored in the ARP tables held by existing host computers that have been communicating. To transmit the new address association relation to the existing host computers that have been communicating, an ARP message is transmitted. The transmission of the ARP message generates a large number of packets, thereby creating the problem of increased network load.

The second problem is the complication of protocols, programs, data, and the like. Specifically, a host computer that uses IP over Ethernet needs a function of transmitting/receiving an ARP message and a function of individually managing the association relation between an IP address and a MAC address which is obtained through the transmission/reception of an ARP message. This causes the problem of complicating protocols, programs, data, and the like for transmitting/receiving packets.

Also with MAC-in-MAC proposed in JP 2002-344476 A, broadcasting a packet is necessary to associate addresses for two layers with each other. The following two problems therefore arise:

The first problem is an increase in network load caused by the broadcasting of a packet. Specifically, the address association relation of a newly introduced host computer, or the address association relation of a host computer that has not been communicating for a while but is about to resume communication, is not held in switches other than one that is connected to the host computer. Consequently, a large number of packets are generated on the WAN to be broadcast, thereby creating the problem of increased network load.

The second problem is the complication of protocols, programs, data, and the like. Specifically, a host computer needs a function of transmitting/receiving a broadcast message for associating an upper-layer address and a lower-layer address with each other and a function of individually managing with the use of a table an address association relation that is obtained through the transmission/reception of a broadcast message. This causes the problem of complicating and expanding protocols, programs, data, and the like.

It is therefore an object of this invention to lessen, in a network where a multilayer (e.g., two-layer) protocol is used and an address is specified in association with each protocol layer, overhead that is caused in the process of sharing the association relation between the addresses, in particular, a problem of increased network load due to the occurrence of broadcast and a problem of the complication and expansion of protocols, programs, data, and the like for the generation of broadcast.

In particular, an object of this invention is to eliminate the functions of generating and managing ARP messages by implementing IP over Ethernet without using an ARP message necessary to associate a MAC address and an IP address with each other. Another object of this invention is to eliminate the functions of generating and managing broadcast messages by implementing Wide Area Ethernet without using a broadcast message necessary to associate a MAC address on a VPN (upper-layer network) (upper-layer address) with the MAC address of an edge switch (a switch disposed at the entrance and a switch disposed at the exit are called edge switches) (lower-layer address).

A representative aspect of this invention is as follows. That is, there is provided a network system, comprising a plurality of computers, and a control apparatus coupled to the plurality of computers via a plurality of network apparatuses. The control apparatus holds a plurality of first addresses and conversion rules for converting each of the plurality of first addresses into a second address, extracts one of the plurality of first addresses and one of the conversion rules when requested by one of the plurality of computers, and transmits the extracted one of the plurality of first addresses and the extracted one of the conversion rules to the one of the plurality of computers that has issued the request. The one of the plurality of computers that has issued the request converts the one of the plurality of first addresses into the second address by using received conversion rule, and holds the converted second address.

According to an aspect of this invention, the problem of increased network load due to the occurrence of broadcast and the problem of the complication and expansion of protocols, programs, and data for the generation of broadcast are lessened.

### BRIEF DESCRIPTION OF THE DRAWINGS

The present invention can be appreciated by the description which follows in conjunction with the following figures, wherein:

FIG. 1 is a block diagram illustrating a configuration of a network according to a first embodiment of this invention;

FIG. 2A is a block diagram illustrating a configuration of a host computers H according to the first embodiment of this invention;

FIG. 2B is a block diagram illustrating a configuration of an address distributing server C according to the first embodiment of this invention;

FIG. 3 is a sequence diagram illustrating processing that is executed when the host computer H is newly introduced according to the first embodiment of this invention;

FIG. 4 is a flow chart illustrating a host address generating processing of the address distributing server C according to the first embodiment of this invention;

FIG. 5 is a flow chart illustrating a self-address calculating/setting processing of the host computer H according to the first embodiment of this invention;

FIG. 6 is an explanatory diagram illustrating a packet converting processing executed by the host computer H according to the first embodiment of this invention;

FIG. 7 is a block diagram illustrating a configuration of a network according to a second embodiment of this invention;

FIG. 8A is a block diagram illustrating a configuration of a WAN switch S according to the second embodiment of this invention;

FIG. 8B is a block diagram illustrating a configuration of an address distributing server C according to the second embodiment of this invention;

FIG. 8C is a block diagram illustrating a configuration of a host computer H according to the second embodiment of this invention;

FIG. 9 is a sequence diagram illustrating processing that is executed when a new virtual network site is connected to the WAN according to the second embodiment of this invention;

FIG. 10 is a flow chart illustrating the switch address generating processing of the address distributing server C according to the second embodiment of this invention;

FIG. 11A is a flow chart illustrating a switch address setting processing executed by each WAN switch S according to the second embodiment of this invention;

FIG. 11B is a flow chart illustrating a host address generation preparing processing executed by each WAN switch S according to the second embodiment of this invention;

FIG. 11C is a flow chart illustrating a host address generating processing executed by each WAN switch S according to the second embodiment of this invention;

FIG. 12 is a flow chart illustrating a self-address calculating/setting processing 918 executed by the host computer H11 (722) according to the second embodiment of this invention;

FIG. 13 is a sequence diagram illustrating communication between the host computers H via the WAN according to the second embodiment of this invention; and

FIG. 14 is a flow chart illustrating the packet converting/transferring processing executed in communication between the host computer H and the host computer H according to the second embodiment of this invention.

### DETAILED DESCRIPTION OF THE PREFERRED EMBODIMENTS

A first embodiment of this invention is described below.

In the following description, the term “broadcast” refers to broadcast or multicast unless otherwise specified.

### First Embodiment

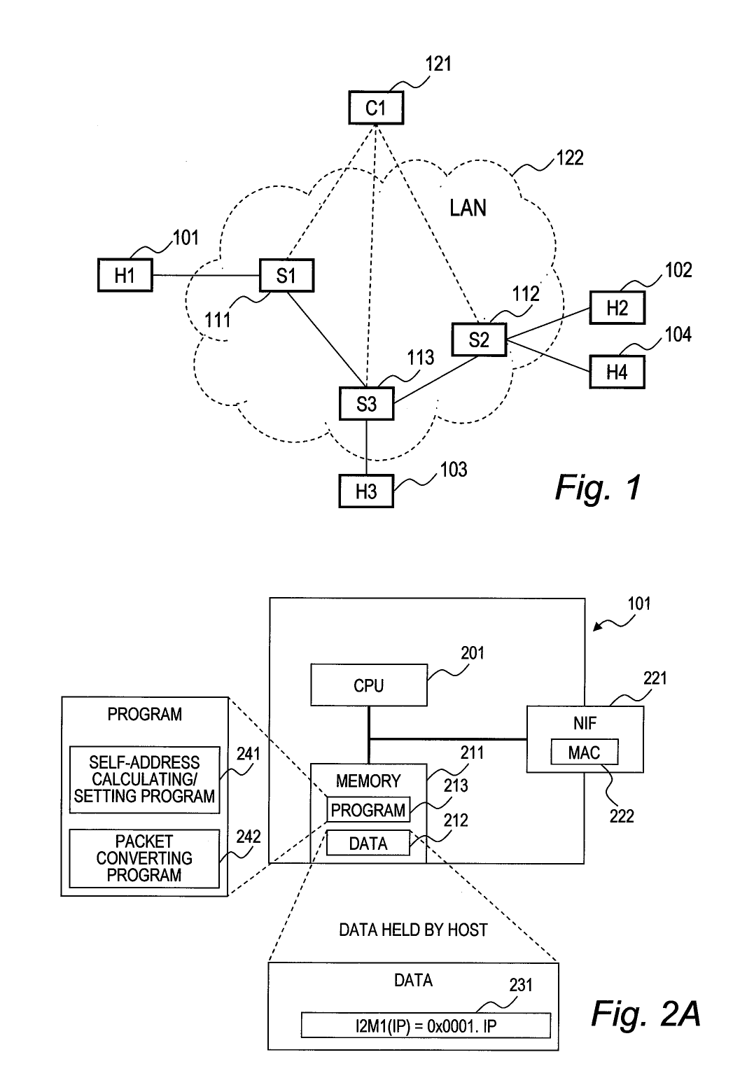

FIG. 1 is a block diagram illustrating the configuration of a network according to the first embodiment of this invention.

The network of the first embodiment includes host computers H1 (101), H2 (102), H3 (103), and H4 (104), switches S1 (111), S2 (112), and S3 (113), an address distributing server C1 (121), and a LAN 122. The LAN 122 is Ethernet implemented by the switches S1 (111), S2 (112), and S3 (113). The switches S1 (111), S2 (112), and S3 (113) have a function of a LAN switch in Ethernet.

The host computer H1 (101) is connected to the switch S1 (111). The host computers H2 (102) and H4 (104) are connected to the switch S2 (112). The host computer H3 (103) is connected to the switch S3 (113).

The address distributing server C1 (121) is connected to one of the switches S described above. This enables the address distributing server C1 (121) to communicate to/from any of the host computers H1 (101), H2 (102), H3 (103) and H4 (104).

In the first embodiment, the host computer H1 (101) and the host computer H2 (102) communicate with each other via a virtual IP network VN1 (Virtual Network 1). The host computer H3 (103) and the host computer H4 (104) communicate with each other via a virtual IP network VN2 (Virtual Network 2).

The host computers H1 (101), H2 (102), H3 (103), and H4 (104) in the first embodiment receives the distribution of IP addresses and an address conversion rule which associates an IP address with a MAC address from the address distributing server C1 (121).

Unlike a network based on conventional IP over Ethernet, the network in the first embodiment allows a plurality of independent virtual IP networks to operate simultaneously on the LAN 122. A virtual IP network in the first embodiment is similar to a so-called virtual network. The virtual IP networks on the LAN 122 are therefore referred to as VN1 (Virtual Network 1), VN2 (Virtual Network 2) . . . in the following description.

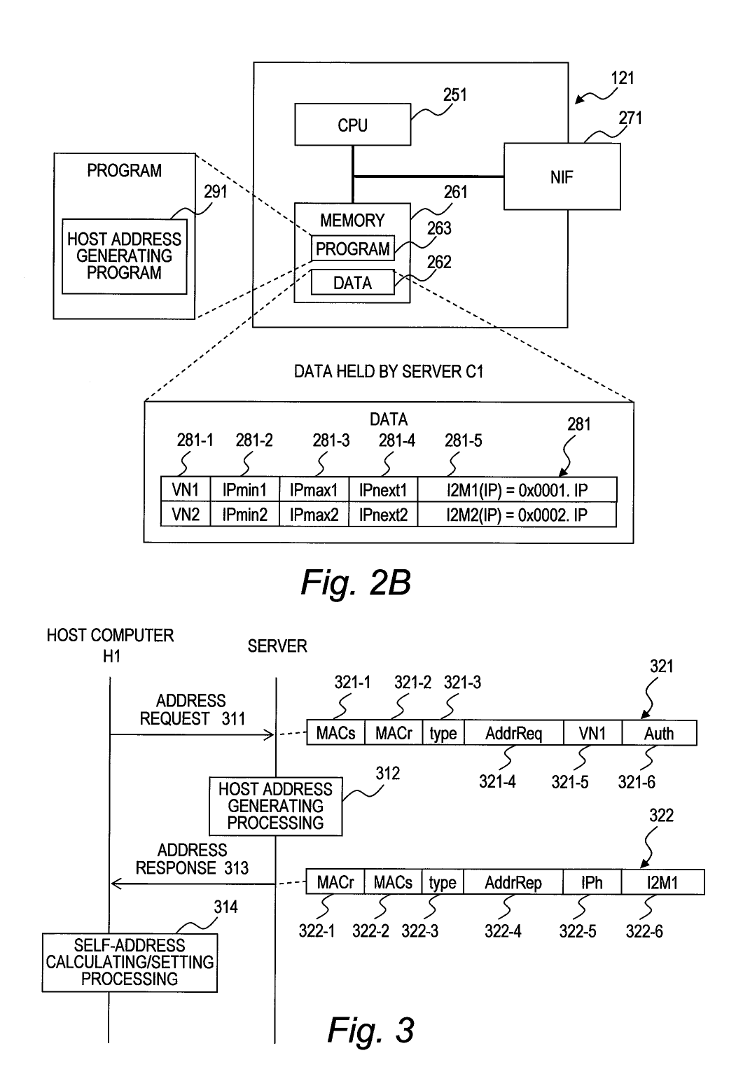

FIG. 2A is a block diagram illustrating the configuration of the host computers H according to the first embodiment of this invention.

The host computers H1 (101), H2 (102), H3 (103), and H4 (104) all have the configuration of FIG. 2A. Each host computer H includes a CPU 201, a memory 211, and a network interface card (NIF) 221. The CPU 201 is a processor and executes a program held in the memory 211.

The memory 211 holds data 212 and a program 213. The data 212 includes an address conversion rule 231. The program 213 includes a self-address calculating/setting program 241 and a packet converting program 242.

The self-address calculating/setting program 241 is a program for implementing the function of an address setting proxy on the host computer H. The self-address calculating/setting program 241 makes an address reflected on the host computer H based on an IP address that is assigned by the address distributing server C1 (121).

The packet converting program 242 is a program for implementing the function of an address converting proxy on the host computer H. The packet converting program 242 converts an IP address within a packet into a MAC address.

The NIF 221 is an interface for enabling the host computer H to communicate to/from the relevant switch S. The NIF 221 stores a MAC address 222, which is assigned uniquely to the NIF 221.

No rule is stored as the address conversion rule 231 in the initial state. After the address distributing server C1 (121) transmits an address conversion rule to the host computer H, the transmitted address conversion rule is stored as the address conversion rule 231.

The address conversion rule 231 of FIG. 2A contains an IP address-to-MAC address conversion rule in which a MAC address is expressed as 0x0001. IP (a 4-byte IP address is converted into a 6-byte MAC address by attaching 0x0001 to the head of the IP address).

FIG. 2B is a block diagram illustrating the configuration of the address distributing server C1 (121) according to the first embodiment of this invention.

The address distributing server C1 (121) includes a CPU 251, a memory 261, and an NIF 271. The CPU 251 is a processor and executes a program held in the memory 261.

The memory 261 holds data 262 and a program 263. The data 262 includes an address conversion rule table 281. The program 263 includes a host address generating program 291.

The address conversion rule table 281 contains in each row a virtual IP network identifier 281-1, a minimum IP address 281-2, a maximum IP address 281-3, a next IP address 281-4, and an address conversion rule 281-5.

As the virtual IP network identifier 281-1, an identifier (numerical value or letter string) for uniquely identifying a virtual IP network in the LAN 122 is stored.

Stored as the minimum IP address 281-2 is a minimum IP address value that is used in the virtual IP network. Stored as the maximum IP address 381-3 is a maximum IP address value that is used in the virtual IP network.

Stored as the next IP address 281-4 is an IP address value that is to be assigned next by the address distributing server C1 (121). Stored as the address conversion rule 281-5 is an address conversion rule.

The address conversion rule table 281 of the first embodiment holds two rows. The first row contains information of VN1 in the LAN 122 and the second row contains information of VN2 in the LAN 122.

In the first embodiment, the address conversion rule 281-5 of VN1 includes an address conversion rule I2M1 (I2M1(IP)=0x0001. IP). The address conversion rule I2M1 represents a function that converts a 4-byte IPv4 address into a 6-byte MAC address by attaching 0x0001 to the head of the IPv4 address.

In the first embodiment, the address conversion rule 281-5 of VN2 includes an address conversion rule I2M2 (I2M2(IP)=0x0002. IP). The address conversion rule I2M2 represents a function that converts a 4-byte IPv4 address into a 6-byte MAC address by attaching 0x0002 to the head of the IPv4 address.

The address conversion rule 281-5 illustrated in FIG. 2B is a rule in which the first two significant bytes are a fixed value such as 0x0001 or 0x0002 and the last four significant bytes are an IP address variable. However, this invention can use any address conversion rule and, for example, a MAC address may be calculated from an IP address and a hash value.

A row may be added to or deleted from the address conversion rule table 281 by a network management server or a network administrator. In other words, the administrator or the management server can increase or decrease the number of virtual IP networks in the LAN 122 by updating the address conversion rule table 281. To add a new virtual IP network to the LAN 122, the same value as a minimum IP address IPmin of the new row is stored as the next IP address 281-4 of the new row.

Processing that is executed when the host computer H1 (101) is newly introduced to the LAN 122 is described below.

FIG. 3 is a sequence diagram illustrating processing that is executed when the host computer H1 (101) is newly introduced according to the first embodiment of this invention.

After connected to the LAN 122, the host computer H1 (101) first transmits an address request 311 to the address distributing server C1 (121) by means of the self-address calculating/setting program 241 in order to request the assignment of its own MAC address.

The address request 311 is transmitted in a packet 321. The packet 321 contains a destination address 321-1 and a source address 321-2, which are fields for storing addresses in an Ethernet frame.

The packet 321 further contains fields for a protocol type 321-3, data 321-4, a virtual IP network identifier 321-5, and authentication information 321-6. The protocol type 321-3 is also contained in the Ethernet frame.

In the address request 311 of FIG. 3, “MACs” is stored in the field for the destination address 321-1 and “MACr” is stored in the field for the source address 321-2. The protocol type of the data 321-4 is stored in the field for the protocol type 321-3.

The fields that follow the Ethernet frame are fields for storing the contents of the address request. “AddrReq” stored in the field for the data 321-4 of the packet 321 is a numerical value indicating that the packet 321 is an address request.

The virtual IP network identifier 321-5 of the packet 321 indicates the identifier of a virtual IP network (VN1) to which the host computer H1 (101) is joined. The identifier stored in the field for the virtual IP network identifier 321-5 may be omitted if there is only one virtual IP network to which the host computer H1 (101) can be joined.

The field for the authentication information 321-6 stores authentication information for determining whether or not the packet 321 has been transmitted correctly.

At the time of transmission of the address request 311, the MAC address of the host computer H1 (101) is not determined yet. “MACr” which is a temporary MAC address is therefore stored in the field for the source address 321-2 of the address request 311. The host computer H1 (101) may use as the temporary MAC address MACr the MAC address 222, which is stored in advance as an initial value in the NIF 221 of the host computer H1 (101).

Alternatively, the host computer H1 (101) may use as the temporary MAC address MACr a MAC address that is reserved in advance for the address request 311. The advantage of using a reserved MAC address is that the switches S provided in the LAN 122 only need to learn a relatively small number of MAC addresses even when the LAN 122 is connected to a large number of host computers H.

However, using a reserved address has a drawback in that a collision between the host computers H that have the same MAC address is possible when a plurality of host computers H are simultaneously introduced to the LAN 122. To lower the probability of collision, the host computer H1 (101) may reserve a plurality of MAC addresses in advance and use a MAC address randomly selected from the reserved MAC addresses at the time the host computers H are introduced.

If a collision is suspected to have occurred, in other words, if a normal response to the address request is not returned, the host computer H1 (101) may randomly select a MAC address again to transmit the address request 311 with the selected MAC address as the temporary MAC address MACr.

“MACs” stored in the field for the destination address 321-1 of the address request 311, which is the address of the address distributing server C1 (121), may be a fixed address. In the case where a fixed address is used as the destination address 321-1 of the address request 311, the host computer H1 (101) does not need to broadcast the address request 311. In the case where a fixed address cannot be used as the destination address 321-1 of the address request 311, the host computer H1 (101) needs to broadcast or multicast the address request 311. In other words, the host computer H1 (101) may store a broadcast address or a multicast address in the field for the destination address 321-1 instead of a fixed address.

When the temporary MAC address MACr of the address request 311 is a MAC address stored in advance as an initial value in the NIF 221 of the host computer H1 (101), MAC address authentication can be used and the packet 321 therefore does not need to store the authentication information 321-6. On the other hand, when the temporary MAC address MACr is an address other than the MAC address held in advance in the NIF 221 and MAC address authentication is accordingly necessary, a value needs to be stored in the field for authentication information 321-6.

The sequence diagram of FIG. 3 illustrates processing in which an address is assigned in one back-and-forth communication session. In the case where a value is stored in the field for authentication information 321-6, communication for performing authentication by an authentication method of the authentication information 321-6 is added to the processing of FIG. 3.

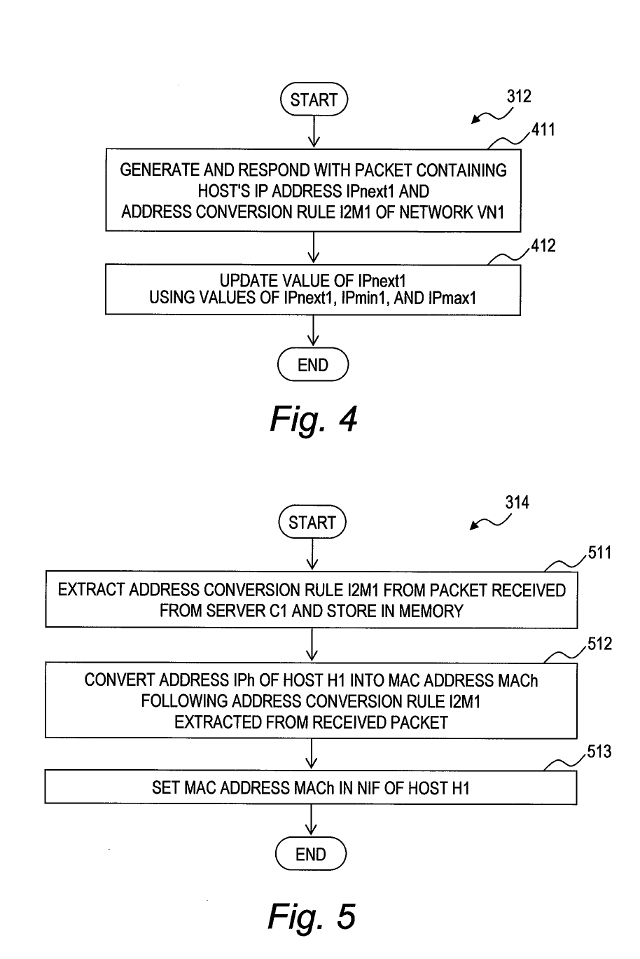

Receiving the address request 311, the address distributing server C1 (121) executes host address generating processing 312, to thereby extract an IP address and an address conversion rule that are to be transmitted to the host computer H1 (101). The host address generating processing 312 is described later with reference to FIG. 4.

After the host address generating processing 312 is finished, the address distributing server C1 (121) transmits an address response 313 to the host computer H1 (101).

The address response 313 is transmitted in a packet 322. The packet 322 contains a destination address 322-1 and a source address 322-2, which are fields for storing addresses in an Ethernet frame.

The packet 322 further contains fields for a protocol type 322-3, data 322-4, an IP address 322-5, and an address conversion rule 322-6. The protocol type 322-3 is also contained in the Ethernet frame.

In the address response 313 of FIG. 3, the same temporary MAC address MACr as the source address 311-2 of the address request 311 is stored in the field for the destination address 322-1. The same address as the destination address 311-1 of the address request 311, namely, “MACs,” is stored in the field for the source address 322-2. The protocol type 322-3 indicates the protocol type of the data 322-4.

The fields that follow the Ethernet frame are fields for storing the contents of the address response. “AddrRep” is stored in the field for the data 322-4 of the packet 322 and contains a numerical value indicating that the packet 322 is an address response.

An IP address to be used by the host computer H1 (101) is stored in the field for the IP address 322-5 of the packet 322. “IPh” is stored as the IP address 322-5 of FIG. 3. The address stored as the IP address 322-5 is an IP address that is extracted through the host address generating processing 312 by the address distributing server C1 (121).

An address conversion rule extracted by the address distributing server C1 (121) is stored in the field for the address conversion rule 322-6. Stored as the address conversion rule 322-6 of FIG. 3 is the value of the address conversion rule 281-5 in a row of the address conversion rule table 281 of FIG. 2B that has VN1 as the IP network identifier 281-1 (I2M1:I2M1(IP)=0x0001. IP).

Receiving the address response 313, the host computer H1 (101) executes self-address calculating/setting processing 314, to thereby calculate a MAC address assigned to the host computer H1 (101). The self-address calculating/setting processing 314 is described later with reference to FIG. 5.

The format for transmitting the address request 311 and the address response 313 does not need to be the one used in the first embodiment described above, and can be any format. For example, Dynamic Host Configuration Protocol (DHCP) standardized in IETF may be used for packets of this invention.

In the case where DHCP is used, the MAC address 222 which is stored in advance as an initial value in the NIF 221 is specified as the temporary MAC address (“MACr” in FIG. 3) of the host computer H1 (101), and nothing is specified as the address of the address distributing server C1 (121) (“MACs” in FIG. 3). In short, the address request 311 is broadcast over the LAN 122.

Processing that is executed when the host computer H3 (103) is introduced to the LAN 122 is described next.

This processing can be read as the processing of FIG. 3 by substituting the host computer H1 (101) with the host computer H3 (103), substituting a value VN1 which is stored as the IP network identifier 321-5 with VN2, and substituting the address conversion rule I2M1 which is stored as the address conversion rule 322-6 with I2M2. “IPh” stored as the IP address 322-5 in the processing of FIG. 3 is also substituted in this processing with an IP address that is assigned to the host computer H3 (103) by the address distributing server C1 (121).

In other words, the host computer H that is connected to another virtual IP network can also receive an IP address and an address conversion rule from the address distributing server C1 (121) through the processing of FIG. 3.

FIG. 4 is a flow chart illustrating the host address generating processing 312 of the address distributing server C1 (121) according to the first embodiment of this invention.

The host address generating processing 312 is processing executed by the host address generating program 291. The host address generating processing 312 is started after the address request 311 is received. The processing described below is the host address generating processing 312 that is executed when the address distributing server C1 (121) receives the packet 321 of FIG. 3.

After the host address generating processing 312 is started, the address distributing server C1 (121) refers to the packet 321 of the address request 311 and extracts a value VN1 stored in the field for the IP network identifier 321-5. The address distributing server C1 (121) uses the extracted value VN1 to search the address conversion rule table 281, and extracts a value IPnext1 of the next IP address 281-4 and a value I2M1 of the address conversion rule 281-5 from a row that has the value VN1 as the IP network identifier 281-1.

The address distributing server C1 (121) stores the extracted value I2M1 in the field for the address conversion rule 322-6 of the packet 322, and stores the extracted value IPnext1 in the field for the IP address 322-5 of the packet 322.

The address distributing server C1 (121) also stores a value MACs of the destination address 321-1 of the packet 321 in the field for the source address 322-2 of the packet 322, and stores a value MACr of the source address 321-2 of the packet 321 in the field for the destination address 322-1 of the packet 322. The address distributing server C1 (121) further stores a value indicating that the packet 322 is an address response and a protocol type in the field for the data 322-4 and the field for the protocol type 322-3, respectively.

After storing values in the packet 322, the address distributing server C1 (121) transmits the packet 322 in which the values have been stored to the host computer H1 (101) (411).

Finishing Step 411, the address distributing server C1 (121) calculates a new IPnext1 value from values of IPnext1, IPmin1, and IPmax1 which are stored as the minimum IP address 281-2, maximum IP address 281-3, and next IP address 281-4 of the address conversion rule table 281. The current value of the next IP address 281-4 is updated with the calculated new IPnext1 value. For instance, 1 is added to the current IPnext1 value and the result of the addition is stored as the next IP address 281-4 (412).

The address distributing server C1 (121) may determine whether or not a new IP address can be generated by determining whether or not the new IPnext1 value is within the range of values from IPmin1 to IPmax1.

In the first embodiment, IP addresses are generated sequentially to be assigned to the host computers H as described above. However, assigning sequential IP addresses may be avoided for such purposes as making it difficult for those with malicious intent to figure out the IP address of their target. For example, pseudo-random numbers may be used to generate IP addresses. If an appropriate pseudo-random number generating function is selected, most of IP addresses within the range between IPmin1 and IPmax1 can be assigned, instead of wasting many IP addresses.

Described next is the host address generating processing 312 that is executed when the address distributing server C1 (121) receives the address request 311 from the host computer H3 (103).

The processing that the address distributing server C1 (121) executes when receiving the address request 311 from the host computer H3 (103) can be read as the processing of FIG. 4 by substituting the value VN1 of the virtual IP network identifier 281-1 with VN2. A value I2M1 of the address conversion rule 281-5, a value IPnext1 of the next IP address 281-4, a value IPmin1 of the minimum IP address 281-2, and a value IPmax1 of the maximum IP address 281-3 in the processing of FIG. 4 are also substituted with I2M2, IPnext2, IPmin2, and IPmax2, respectively, in this processing.

FIG. 5 is a flow chart illustrating the self-address calculating/setting processing 314 of the host computer H1 (101) according to the first embodiment of this invention.

The self-address calculating/setting processing 314 is processing executed by the self-address calculating/setting program 241 of each host computer H. The self-address calculating/setting processing 314 is started after the address response 313 is received. The processing described below is the self-address calculating/setting processing 314 that is executed when the host computer H1 (101) receives the packet 322 of FIG. 3.

After the self-address calculating/setting processing 314 is started, the host computer H1 (101) extracts a value IPh of the IP address 322-5 and a value I2M1 of the address conversion rule 322-6 from the packet 322 received from the address distributing server C1 (121), and stores the extracted address conversion rule value I2M1 in the memory 211 (511). Specifically, the host computer H1 (101) stores the extracted address conversion rule value I2M1 as the address conversion rule 231 included in the data 212.

Finishing Step 511, the host computer H1 (101) uses the address conversion rule value I2M1 extracted in Step 511 to convert the IP address value IPh extracted from the packet 322 into a MAC address MACh (512). In other words, the host computer H1 (101) converts an IP address assigned by the address distributing server C1 (121) into the MAC address of the host computer H1 (101).

After Step 512, the host computer H1 (101) stores the MAC address MACh obtained through the conversion as the MAC address 222 in the NIF 221 (513).

Described next is the self-address calculating/setting processing 314 that is executed when the host computer H3 (103) receives the address response 313.

The processing that is executed when the host computer H3 (103) receives the address response 313 can be read as the processing of FIG. 5 by substituting the host computer H1 (101) with the host computer H3 (103), substituting the address conversion rule value I2M1 with I2M2, and substituting the IP address value IPh with an IP address value that is assigned to the host computer H3 (103).

Through the processing of FIGS. 3, 4, and 5 described above, the host computer H that is introduced to the LAN 122 is assigned a MAC address and is given an address conversion rule. The assignment of a MAC address and the giving of an address conversion rule that are illustrated in FIGS. 3, 4, and 5 may be executed at a time requested by the host computer H, as well as when the host computer H is introduced to the LAN 122 for the first time.

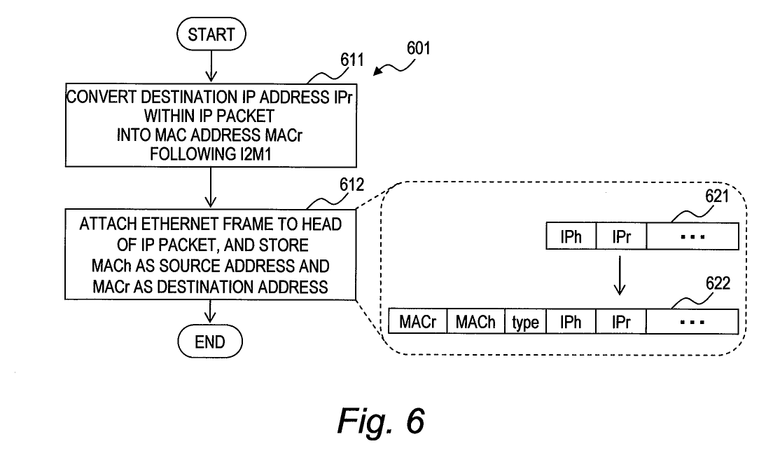

Communication between the host computer H1 (101) and the host computer H2 (102), which has been connected to the LAN 122 in advance, is described next. In communication between the host computer H1 (101) and the host computer H2 (102), the program 213 of the host computer H1 (101) generates an IP packet. Through packet converting processing 601 (described later with reference to FIG. 6), the packet converting program 242 (an address converting proxy) of the host computer H1 (101) attaches an Ethernet frame to the head of the IP packet generated by the program 213, and transmits the IP packet thus turned into an Ethernet packet to the host computer H2 (102).

When transmitting the Ethernet packet, the host computer H1 (101) is already holding the IP address of the host computer H2 (102), or obtains through a search with the use of a DNS. The host computer H2 (102) receives the Ethernet packet and removes the Ethernet frame to have the program 213 of the host computer H2 (102) process the resultant packet as an IP packet.

FIG. 6 is an explanatory diagram illustrating the packet converting processing 601 which is executed by the host computer H1 (101) according to the first embodiment of this invention.

The packet converting processing 601 is processing executed by the packet converting program 242 of the host computer H1 (101). The packet converting processing 601 is started when the host computer H1 (101) receives an IP packet 621 generated by the program 213 of the host computer H1 (101).

After the packet converting processing 601 is started, the host computer H1 (101) uses a value I2M1 stored as the address conversion rule 231 to convert a destination IP address IPr in the IP packet 621 into a MAC address MACr (611).

Finishing Step 611, the host computer H1 (101) attaches an Ethernet frame to the head of the IP packet 621. Specifically, a MAC address MACh of the host computer H1 (101) (namely, the MAC address 222 stored in the NIF 221) is stored as the source address of the Ethernet frame, and the MAC address MACr obtained through the conversion in Step 611 is stored as the destination address. An Ethernet packet 622 is generated as a result (612).

The address MACh used in Step 611 is MACh stored in the NIF 221 when the host computer H1 (101) is connected to the LAN 122, namely, MACh stored in Step 513 of FIG. 5.

Having obtained the address conversion rule I2M1 when connected to the LAN 122, the host computer H1 (101) can calculate a destination MAC address from the address conversion rule, and does not need to hold the association relation between a destination IP address and a destination MAC address in advance. In short, the system according to the first embodiment does not need to broadcast in advance the association relation between an IP address, which belongs to the upper layer, and a MAC address, which belongs to the lower layer.

Described next is the packet converting processing 601 that is executed when the host computer H3 (103) receives an IP packet. This processing can be read as the processing of FIG. 6 by substituting the address conversion rule I2M1 with I2M2, substituting “IPh” with an IP address that is assigned to the host computer H3 (103) by the address distributing server C1 (121), and substituting an address IPr of the host computer H2 (102) with the MAC address of the host computer H3 (103).

The processing of FIG. 3 enables the host computer H1 (101) to communicate to/from the host computer H2 (102) over the virtual IP network VN1, and a communication sequence equivalent to FIG. 3 that is performed between the host computer H3 (103) and the address distributing server C1 (121) enables the host computer H3 (103) to communicate to/from the host computer H4 (104) over the virtual IP network VN2.

There is no duplication between a MAC address generated with the use of the address conversion rule I2M1, which is associated with the virtual IP network VN1, and a MAC address generated with the use of the address conversion rule I2M2, which is associated with the virtual IP network VN2. Communication in VN1 and communication in VN2 therefore do not interfere with each other. In other words, isolation necessary for virtual IP networks is realized according to the processing of FIG. 3. Modification examples of the first embodiment are described below.

The first embodiment has a drawback in that, when a plurality of virtual IP networks are generated and one of the host computers H uses an invalid address conversion rule to access a virtual IP network that the host computer H is not authorized to access, the unauthorized access cannot be detected or prohibited.

This drawback is overcome in a first example of the first embodiment in which each LAN switch S is configured to discard a packet received from one of the host computers H if the packet does not contain a MAC address associated with a specific virtual IP network, so as to avoid duplication between MAC addresses obtained by converting IP addresses in different virtual IP networks.

Many of commercially available LAN switches have this function of allowing only packets that contain a specific MAC address to pass. It may also be a network management server or a network administrator that sets the LAN switches S in this manner at the time virtual IP networks are generated. Alternatively, the address distributing server C1 (121) transmitting the address response 313 may set the LAN switches S such that a MAC address assigned to the destination host computer H is allowed to pass. In this case, the LAN switches need to be set in advance so as to allow a passage to packets containing the initial MAC address value MACr of the host computers H because, otherwise, the address request 311 cannot reach the address distributing server C1 (121).

In the first embodiment, one host computer H can be joined to only one of the plurality of virtual IP networks. A second example of the first embodiment allows each host computer H to join a plurality of virtual IP networks by providing the host computer H with a plurality of NIFs 221. Specifically, a plurality of NIFs 221 are installed in each host computer H and a different virtual IP network is designated for each of the NIFs 221. The sequence of FIG. 3 is then executed.

However, a specific IP address in the host computer H having a plurality of NIFs 221 belongs to one of the virtual IP networks and the host computer H therefore cannot communicate with the host computer H that holds the same IP address on a different virtual IP network.

In the first embodiment, packets used for communication in the LAN 122 are the same as those used in normal IP over Ethernet, and contain an IP header and an Ethernet header both. The IP header is necessary to enable the host computer H receiving a packet to restore an IP packet to a state that the IP packet has been in upon transmission by simply removing the header of an Ethernet frame from the received packet.

However, in the case where IP addresses and Ethernet addresses are associated with each other on a one-on-one basis, the host computer H receiving a packet from which an IP header has been removed by the host computer H transmitting the packet can restore the IP header from the packet's Ethernet header.

In a third example of the first embodiment, when IP addresses and Ethernet addresses are associated with each other on a one-on-one basis, the IP address IPh and the IP address IPr may not be stored in the packet 622 in Step 612 of the packet converting processing 601 executed by the host computer H1 (101).

Then, if the host computer H2 (102) receives the packet 622 after the processing of FIG. 6, the host computer H2 (102) obtains IPh and IPr by inversely applying the address conversion rule I2M1 to MACh and MACr, and attaches an IP header that contains the IP address IPh and the IP address IPr in place of the Ethernet header of the packet 622.

The third example of the first embodiment uses Ethernet switches as in the first embodiment. If switches that learn IP addresses are used instead of Ethernet switches, the host computers H do not need to convert the header format. Specifically, this eliminates the need for the host computer H1 (101) to execute Step 612 and for the host computer H2 (102) to convert addresses and to switch packet headers.

According to the first embodiment, the address distributing server C1 (121) transmits an IP address and an address conversion rule to each host computer H, thereby eliminating the need for the host computers H to hold the association relation between an IP address, which belongs to the upper layer, and a MAC address, which belongs to the lower layer. This means that the problem of increased network load due to broadcast and the problem of the complication and expansion of protocols, programs, and data for the generation of broadcast are lessened.

### Second Embodiment

A second embodiment of this invention is described below.

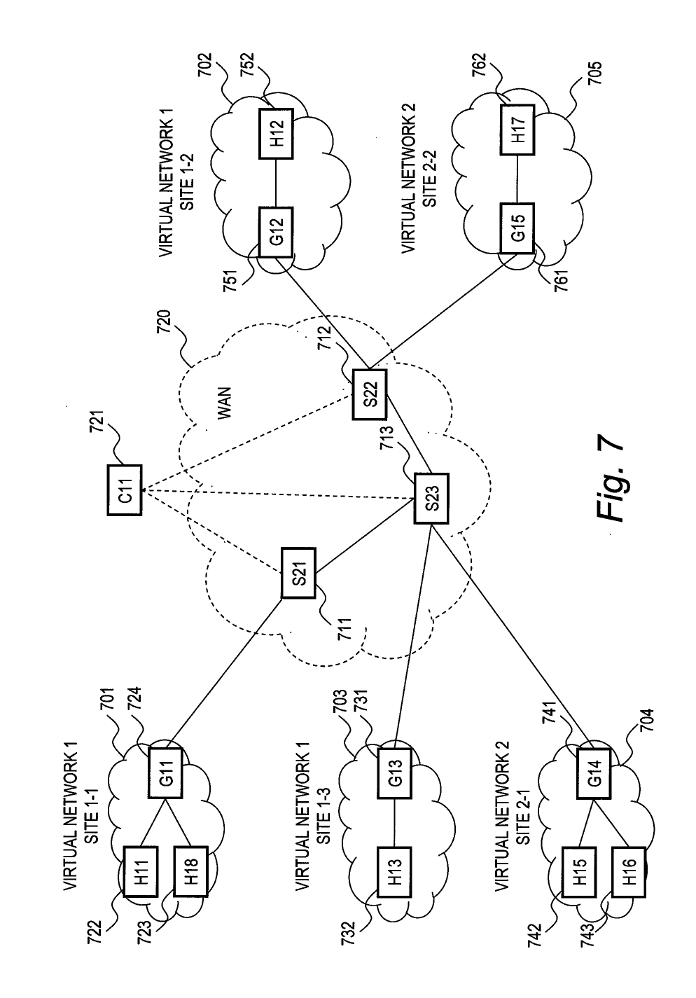

FIG. 7 is a block diagram illustrating the configuration of a network according to the second embodiment of this invention.

The network of the second embodiment includes a wide area network (WAN) 720, WAN switches S21 (711), S22 (712), and S23 (713), an address distributing server C11 (721), LAN switches G11 (724), G12 (751), G13 (731), G14 (741), and G15 (761), host computers H11 (722), H12 (752), H13 (732), H15 (742), H16 (743), and H17 (762), and virtual network sites 1-1 (701), 1-2 (702), 1-3(703), 2-1 (704), and 2-2 (705).

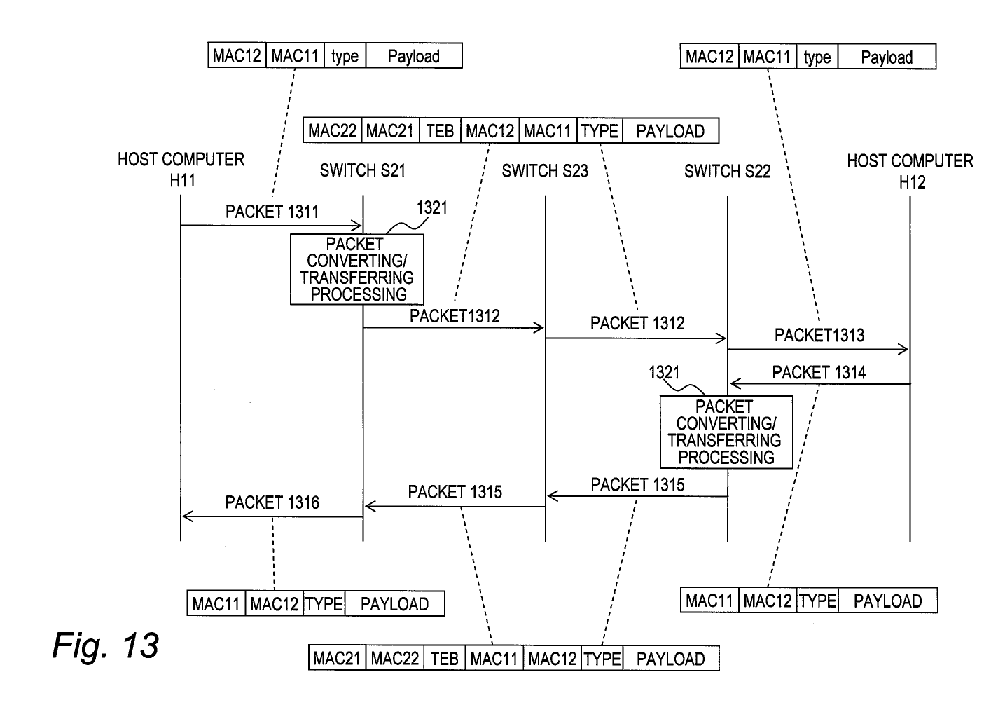

The WAN 720 is implemented by WAN switches S21 (711), S22 (712), and S23 (713). The WAN switches S21 (711), S22 (712), and S23 (713) have the function of a normal Ethernet LAN switch and also have the function of a gateway between a LAN and a WAN. This gateway function is described later with reference to FIG. 13.

The WAN switch S21 (711) is connected to the virtual network site 1-1 (701) of a virtual network 1 via the LAN switch G11 (724). Connected to the LAN switch G11 (724) are the host computer H11 (722) and the host computer H18 (723).

The WAN switch S23 (713) is connected to the virtual network site 1-3 (703) of the virtual network 1 via the LAN switch G 13 (731). Connected to the LAN switch G13 (731) is the host computer H13 (732). The WAN switch S23 (713) is also connected to the virtual network site 2-1 (704) of a virtual network 2 via the LAN switch G 14 (741). Connected to the LAN switch G 14 (741) are the host computer H15 (742) and the host computer H16 (743).

The WAN switch S22 (712) is connected to the virtual network site 1-2 (702) of the virtual network 1 via the LAN switch G12 (751). Connected to the LAN switch G12 (751) is the host computer H12 (752).

The WAN switch S22 (712) is connected to the virtual network site 2-2 (705) of the virtual network 2 via the LAN switch G15 (761). Connected to the LAN switch G 15 (761) is the host computer H17 (762).

The address distributing server C11 (721) is connected to one of the WAN switches S, namely, the WAN switches S21 (711), S22 (712), and S23 (713). This enables the address distributing server C11 (721) to communicate from/to any of the host computers H.

In the second embodiment, the host computer H11 (722) and the host computer H12 (752) communicate with each other via a virtual network (virtual Ethernet) VN1 (Virtual Network 1). The host computer H15 (742) and the host computer H17 (762) communicate with each other via a virtual network (virtual Ethernet) VN2 (Virtual Network 2).

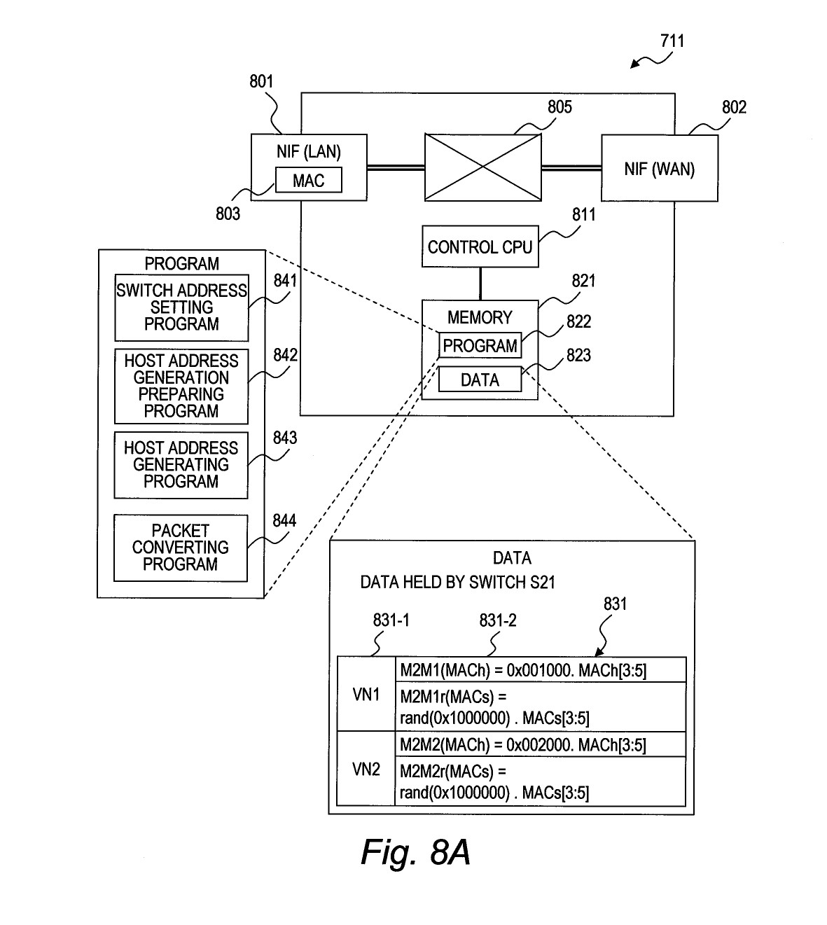

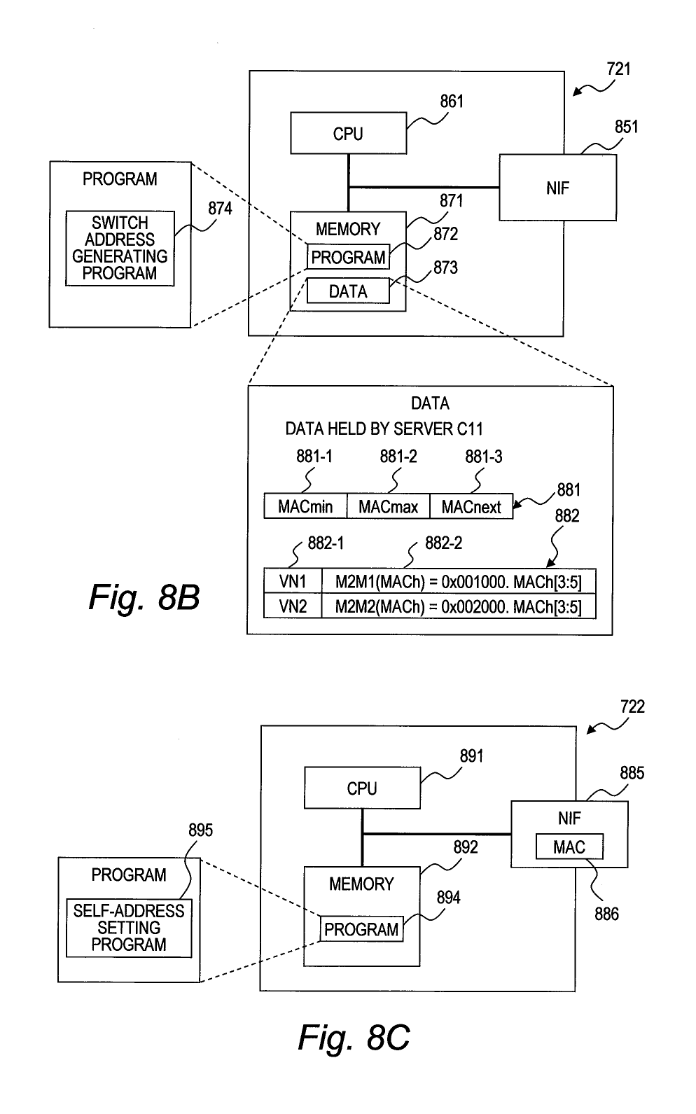

FIG. 8A is a block diagram illustrating the configuration of the WAN switch S according to the second embodiment of this invention.

The WAN switches S21 (711), S22 (712), and S23 (713) each have the configuration of FIG. 8A. Each WAN switch S includes a LAN NIF 801, a WAN NIF 802, a control CPU 811, and a memory 821.

The WAN switch S includes at least one WAN NIF 802 and at least one LAN NIF 801. The LAN NIF 801 holds a MAC address 803. The WAN NIF 802 and the LAN NIF 801 are connected to each other via a transmission/reception processing portion 805 to transmit/receive packets to/from each other.

The WAN switch S includes a control CPU 811 for controlling the WAN switch S. A memory 821 is connected to the control CPU 811.

The memory 821 holds a program 822 and data 823. The data 823 includes an address conversion rule table 831. The address conversion rule table 831 contains in each row a virtual network identifier 831-1 and an address conversion rule 831-2.

The address conversion rule 831-2 includes an address conversion rule M2M1 for converting the MAC address of the relevant host computer H into the MAC address of the WAN switch S, and a function M2M1r for generating from the MAC address of the WAN switch S a MAC address to be assigned to the relevant host computer H.

While nothing is stored in the address conversion rule table 831 in the initial state, the address conversion rule table 831 illustrated in FIG. 8A is storing information about two virtual networks. In other words, what is illustrated in FIG. 8A is the address conversion rule table 831 after address conversion rules of the virtual network VN1 and the virtual network VN2 are received from the address distributing server C11 (721).

The first address conversion rule 831-2 found in rows of the address conversion rule table 831 that are associated with the virtual network VN1 includes a conversion rule in which the MAC address of the WAN switch S is generated by replacing the first three bytes of the MAC address of the relevant host computer H with 0x001000. The first address conversion rule 831-2 found in rows of the address conversion rule table 831 that are associated with the virtual network VN2 includes a conversion rule in which the MAC address of the WAN switch S is generated by replacing the first three bytes of the MAC address of the relevant host computer H with 0x002000.

A row may be added to or deleted from the address conversion rule table 831 by a network management server or a network administrator. In other words, the network administrator or the network management server can increase or decrease the number of virtual networks by updating the address conversion rule table 831.

The program 822 includes a switch address setting program 841, a host address generation preparing program 842, and a host address generating program 843.

FIG. 8B is a block diagram illustrating the configuration of the address distributing server C11 (721) according to the second embodiment of this invention.

The address distributing server C11 (721) includes a CPU 861, a memory 871, and an NIF 851. The CPU 861 is a processor for executing a program held in the memory 871.

The memory 871 holds a program 872 and data 873. The data 873 includes MAC address generation data 881 and an address conversion rule table 882. The program 872 includes a switch address generating program 874.

The address generation data 881 contains elements which are a minimum MAC address 881-1 (MACmin), a maximum MAC address 881-2 (MACmax), and a next MAC address 881-3 (MACnext).

In the second embodiment, the MAC addresses of the WAN switches S and the host computers H are unique throughout the WAN 720. The address distributing server C11 (721) therefore holds only one set of the minimum MAC address 881-1 (MACmin), the maximum MAC address 881-2 (MACmax), and the next MAC address 881-3 (MACnext) as the address generation data 881.

The address conversion rule table 882 is configured as follows:

The address conversion rule table 882 contains in each row a virtual network identifier 882-1 and an address conversion rule 882-2. An address conversion rule used in a virtual network that is indicated by the virtual network identifier 882-1 is stored as the address conversion rule 882-2.

The address conversion rule table 882 of FIG. 8B has two rows: one holds a numerical value or a letter string that indicates the virtual network VN1 as the virtual network identifier 882-1 and the other holds a numerical value or a letter string that indicates the virtual network VN2 as the virtual network identifier 882-1.

In the row for the virtual network VN1, the address conversion rule M2M1 (M2M1(MACh)=0x001000. MACh [3:5]) is stored as the address conversion rule 882-2. In the row for the virtual network VN2, an address conversion rule M2M2 (M2M2(MACh)=0x002000. MACh [3:5]) is stored as the address conversion rule 882-2.

FIG. 8C is a block diagram illustrating the configuration of the host computer H according to the second embodiment of this invention.

The host computers H11 (722), H12 (752), H13 (732), H15 (742), H16 (743), and H17 (762) all have the configuration of FIG. 8C.

Each host computer H11 (722) includes a CPU 891, a memory 892, and a NIF 885. The CPU 891 is a processor for executing a program 894 held in the memory 892.

The memory 892 holds the program 894. The program 894 includes a self-address setting program 895. The NIF 885 holds a MAC address 886 set in the NIF 885.

Processing executed when a new virtual network site is connected to the WAN 720 and at least one host computer H is added is described below.

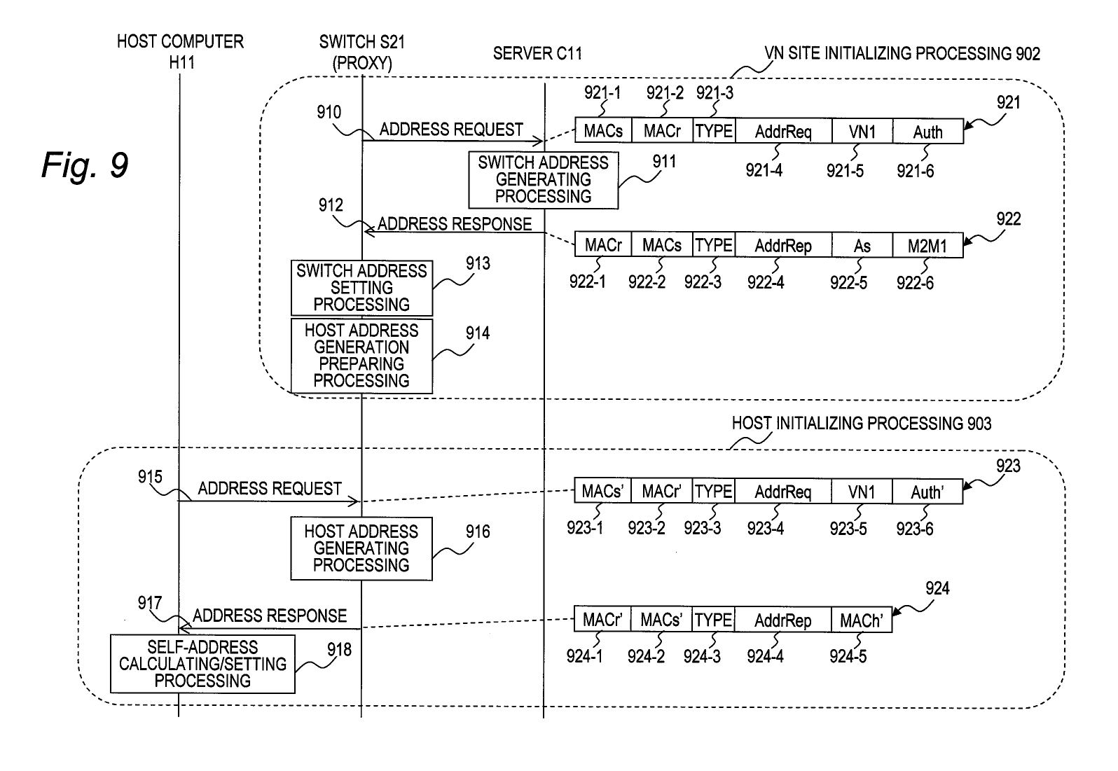

FIG. 9 is a sequence diagram illustrating processing that is executed when a new virtual network site is connected to the WAN 720 according to the second embodiment of this invention.

The processing of FIG. 9 contains virtual network site initializing processing 902 and host computer initializing processing 903. The virtual network site initializing processing 902 is executed repeatedly each time a new virtual network site is introduced. The host computer initializing processing 903 is executed repeatedly each time a new host computer H is introduced. The following description is about processing that is executed when the virtual network site 1-1 (701) alone is newly added accompanied by the addition of the host computer H11 (722) alone.

After the virtual network site 1-1 (701) is introduced to the WAN 720, the WAN switch S21 (711) is notified that the virtual network site 1-1 (701) belongs to the virtual network 1.

That the virtual network site 1-1 (701) belongs to the virtual network 1 is notified to the WAN switch S21 (711) by a network administrator or a network management server. Specifically, the network administrator or the network management server notifies the identifier VN1 of the virtual network 1 and the identifier of the NIF 801 of the WAN switch S21 (711) which is connected to the LAN switch G11 to the WAN switch S21 (711). This starts the virtual network site initialization processing 902 of FIG. 9. After notified that the virtual network site 1-1 (701) belongs to the virtual network 1, the WAN switch S21 (711) first uses the switch address setting program 841 to transmit an address request 910 to the address distributing server C11 (721).

The address request 910 is transmitted in a packet 921. The packet 921 contains a destination address 921-1 and a source address 921-2, which are fields for storing addresses in an Ethernet frame.

The packet 921 further contains fields for a protocol type 921-3, data 921-4, a virtual network identifier 921-5, and authentication information 921-6. The protocol type 921-3 is also contained in the Ethernet frame.

In the address request 910 of FIG. 9, “MACs” is stored in the field for the destination address 921-1 and “MACr” is stored in the field for the source address 921-2. The protocol type 921-3 indicates the protocol type of the data 921-4.

The fields that follow the Ethernet frame are fields for storing the contents of the address request. “AddrRep” stored in the field for the data 921-4 of the packet 921 contains a numerical value indicating that the packet 921 is an address request. The virtual network identifier 921-5 of the packet 921 indicates the identifier of a virtual network site to which the WAN switch S21 (711) is joined. Authentication information for determining whether or not the packet 921 has been transmitted correctly is stored in the field for the authentication information 921-6.

At the time of transmission of the address request 910, the MAC address to be set in the NIF 801 of the WAN switch S21 (711) is not determined yet. “MACr” which is a temporary MAC address is therefore stored in the packet 921 of the address request 910. The WAN switch S21 (711) may use as the temporary MAC address MACr the MAC address 803, which is stored in advance as an initial value in the NIF 801 of the WAN switch S21 (711).

Alternatively, the WAN switch S21 (711) may use as the temporary MAC address MACr an address that is reserved in advance for the address request 910. The advantage of using a reserved address is that, even when the WAN 720 has many WAN switches S, the other WAN switches S provided in the WAN 720 only need to learn a relatively small number of MAC addresses.

However, using a reserved address has a drawback in that a collision between virtual network sites that have the same MAC address is possible when a plurality of virtual network sites are simultaneously introduced to the WAN 720. To lower the probability of collision, the WAN switch S21 (711) may reserve a plurality of MAC addresses in advance and use a MAC address randomly selected from the reserved MAC addresses at the time the virtual network sites are introduced. If a collision is suspected to have occurred, in other words, if a normal response to the address request 910 is not returned, the WAN switch S21 (711) may randomly select a MAC address again to transmit the address request 910.

“MACs” stored in the field for the destination address 921-1 of the address request 910, which is the address of the address distributing server C11 (721), may be a fixed address. In the case where a fixed address is used as the destination address in the address request 910, the WAN switch S21 (711) does not need to broadcast the address request 910. In the case where a fixed address cannot be used, the WAN switch S21 (711) needs to broadcast the address request 910.

When the temporary MAC address MACr of the address request 910 is a MAC address stored in advance as an initial value in the NIF 801 of the WAN switch S21 (711), MAC address authentication can be used and the packet 921 therefore does not need to store the authentication information 921-6. On the other hand, when the temporary MAC address MACr of the WAN switch S21 (711) is an address other than the MAC address held in advance in the NIF 801 and MAC address authentication is accordingly necessary, a value needs to be stored in the field for authentication information 921-6.

The virtual network site initializing processing 902 of FIG. 9 is processing in which a MAC address is assigned in one back-and-forth communication session. In the case where a value is stored in the field for authentication information 921-6, communication for performing authentication by an authentication method of the authentication information 921-6 is added to the virtual network site initializing processing 902.

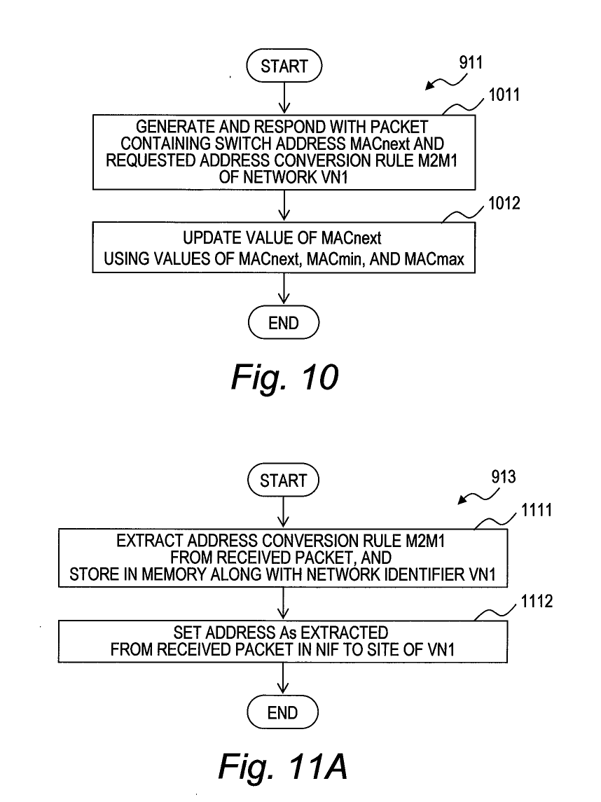

Receiving the address request 910, the address distributing server C11 (721) executes switch address generating processing 911, to thereby extract a MAC address and an address conversion rule that are to be assigned to the WAN switch S21 (711). The switch address generating processing 911 is described later with reference to FIG. 10.

After the switch address generating processing 911 is finished, the address distributing server C11 (721) transmits an address response 912 to the WAN switch S21 (711).

The address response 912 is transmitted in a packet 922. The packet 922 contains a destination address 922-1 and a source address 922-2, which are fields for storing addresses in an Ethernet frame.

The packet 922 further contains fields for a protocol type 922-3, data 922-4, a MAC address 922-5, and an address conversion rule 922-6. The protocol type 922-3 is also contained in the Ethernet frame.

In the address response 912 of FIG. 9, “MACr” is stored in the field for the destination address 922-1 and “MACs” is stored in the field for the source address 922-2. The protocol type of the data 922-4 is stored in the field for the protocol type 922-3. The data 922-4 includes “AddrRep” (a numerical value) which indicates that the packet 922 is an address response.

An MAC address to be used by the WAN switch S21 (711) is stored in the field for the MAC address 922-5 of the packet 922. A value As is stored as the MAC address 922-5 of FIG. 9.

The address conversion rule M2M1 is stored in the field for the address conversion rule 922-6 of FIG. 9. The address conversion rule M2M1 is a value M2M1(MACh)=0x001000. MACh [3:5] of the address conversion rule 882-2 in a row of the address conversion rule table 831 that has VN1 as the virtual network identifier 831-1.

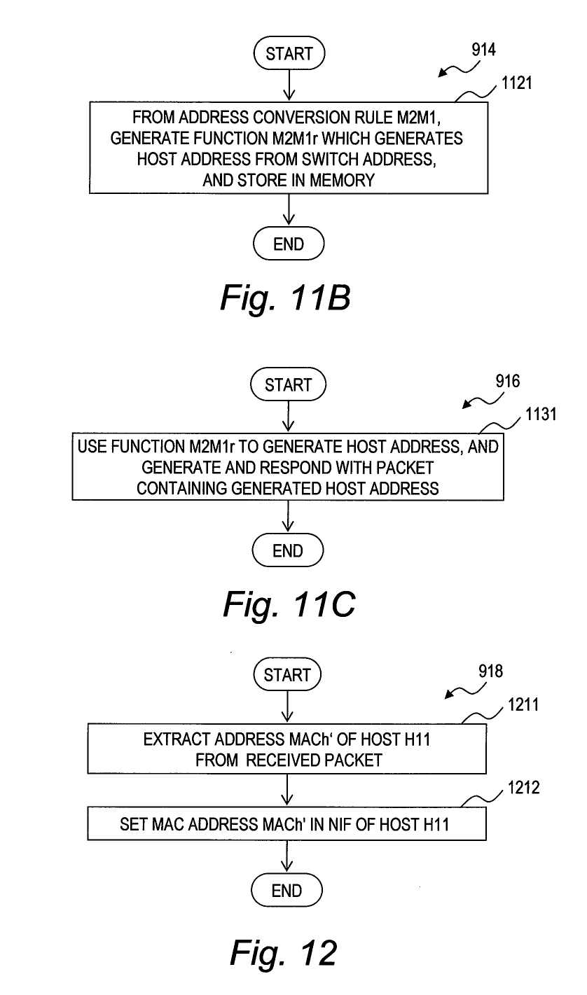

Receiving the address response 912, the WAN switch S21 (711) executes switch address setting processing 913. The switch address setting processing 913 is described later with reference to FIG. 11A.

The format for transmitting the address request 910 and the address response 912 in the second embodiment does not need to be the one described above, and can be any format. For example, DHCP standardized in IETF may be used for packets of the second embodiment.

In the case where DHCP is used, the MAC address 803 which is stored in advance as an initial value in the NIF 801 of the WAN switch S21 (711) is specified as the MAC address (“MAC” in FIG. 9) of the WAN switch S21 (711), and the address of the address distributing server C11 (721) (“MACs” in FIG. 9) is not specified in the address request 910. In short, the address request 910 is broadcast over the WAN 720.

After the switch address setting processing 913, the WAN switch S21 (711) executes host address generation preparing processing 914. The host address generation preparing processing 914 is described later with reference to FIG. 11B.

While the virtual network site initializing processing 902 is executed at the time the virtual network site 1-1 (701) is connected to the WAN switch S21 (711) in the description given above, the WAN switch S21 (711) may transmit the address request 910 to the address distributing server C11 (721) as the need arises to request the assignment of a MAC address and the giving of an address conversion rule.

In the case where the host computer H11 (722) is newly introduced after the virtual network site initializing processing 902, the host computer initializing processing 903 is executed. In the host computer initializing processing 903, the host computer H11 (722) transmits an address request 915 to the WAN switch S21 (711) in order to request the assignment of its own MAC address.

The address request 915 is transmitted in a packet 923. The packet 923 contains a destination address 923-1 and a source address 923-2, which are fields for storing addresses in an Ethernet frame.

The packet 923 further contains fields for a protocol type 923-3, data 923-4, a virtual network identifier 923-5, and authentication information 923-6. The protocol type 923-3 is also contained in the Ethernet frame.

In the address request 915 of FIG. 9, “MACs'” is stored in the field for the destination address 923-1 and “MACr'” is stored in the field for the source address 923-2. The field for the protocol type 923-3 indicates the protocol type of the data 923-4.

The fields that follow the Ethernet frame are fields for storing the contents of the address request. “AddrReq” stored in the field for the data 923-4 of the packet 923 is a numerical value indicating that the packet 923 is an address request. The virtual network identifier 923-5 of the packet 923 indicates the identifier of a virtual network to which the host computer H11 (722) is joined.

The virtual network identifier stored in the field for the virtual network identifier 923-5 may be omitted if there is only one virtual network to which the host computer H11 (722) can be joined. The field for the authentication information 923-6 stores authentication information for determining whether or not the packet 923 has been transmitted correctly.

At the time of transmission of the address request 915, the MAC address of the host computer H11 (722) is not determined yet. “MACr'” which is a temporary MAC address is therefore stored in the field for the packet 923 of the address request 915. The host computer H11 (722) may use as the temporary MAC address MACr′ the MAC address 886, which is stored in advance as an initial value in the NIF 885 of the host computer H11 (722).

Alternatively, the host computer H11 (722) may use as the temporary MAC address MACr′ a MAC address that is reserved in advance for the address request 915. The advantage of using a reserved MAC address is that the LAN switches G provided in the virtual network site 1-1 (701) only need to learn a relatively small number of MAC addresses even when the virtual network site 1-1 (701) is provided with a large number of host computers H.

However, using a reserved address has a drawback in that a collision between the host computers H that have the same MAC address is possible when a plurality of host computers H are simultaneously introduced to the virtual network site 1-1 (701). To lower the probability of collision, the host computer H11 (722) may reserve a plurality of MAC addresses in advance and use a MAC address randomly selected from the reserved MAC addresses at the time the host computers H are introduced.

If a collision is suspected to have occurred, in other words, if a normal response to the address request 915 is not returned, the host computer H11 (722) may randomly select a MAC address again to transmit the address request 915.

“MACs” stored in the field for the destination address 932-1 of the address request 915, which is the address of the WAN switch S21 (711), may be a fixed address. In the case where a fixed address is used for the address request 915, the host computer H11 (722) does not need to broadcast the address request 915. In the case where a fixed address cannot be used, the host computer H11 (722) needs to broadcast the address request 915.

When the address request 915 uses a MAC address stored in advance as an initial value in the NIF 885 of the host computer H11 (722), MAC address authentication can be used and the packet 923 therefore does not need to store the authentication information 923-6. On the other hand, when addresses other than the MAC address 886 stored in advance in the NIF 885 are used as the MAC address of the host computer H11 (722) and MAC address authentication is accordingly necessary, a value needs to be stored in the field for authentication information 321-6.

The host computer initializing processing 903 of FIG. 9 illustrates processing in which an address is assigned to the host computer H11 (722) in one back-and-forth communication session. In the case where a value is stored in the field for authentication information 923-6, communication for performing authentication by an authentication method of the authentication information 923-6 is added to the processing of FIG. 9.

After receiving the address request 915, the WAN switch S21 (711) executes host address generating processing 916 and generates a MAC address to be assigned to the host computer H11 (722). The host address generating processing 916 is described later with reference to FIG. 11C.

Finishing the host address generating processing 916, the address distributing server C11 (721) transmits an address response 917 to the host computer H11 (722).

The address response 917 is transmitted in a packet 924. The packet 924 contains a destination address 924-1 and a source address 924-2, which are fields for storing addresses in an Ethernet frame.

The packet 924 further contains fields for a protocol type 924-3, data 924-4, and the MAC address 924-5. The protocol type 924-3 is also contained in the Ethernet frame.

In the address response 917 of FIG. 9, “MACr'” is stored in the field for the destination address 924-1 and “MACs'” is stored in the field for the source address 924-2. The protocol type 924-3 indicates the protocol type of the data 924-4.

The fields that follow the Ethernet frame are fields for storing the contents of the address request. “AddrRep” (numerical value) stored in the field for the data 924-4 of the packet 924 is a value indicating that the packet 924 is an address response.

Stored in the field for the MAC address 924-5 is a value MACh′ which is a MAC address to be used by the host computer H11 (722).

Receiving the address response 917, the host computer H11 (722) executes self-address calculating/setting processing 918. The self-address calculating/setting processing 918 is processing executed by the self-address setting program 895. The self-address calculating/setting processing is described later with reference to FIG. 12.

The format for transmitting the address request 915 and the address response 917 does not need to be the one described above, and can be any format. For example, DHCP standardized in IETF may be used for packets of the second embodiment.

In the case where DHCP is used, the MAC address 886 which is stored in advance as an initial value in the NIF 885 is specified as the MAC address of the host computer H11 (722) (“MACr” in FIG. 9), and the address of the WAN switch S21 (711) (“MACs” in FIG. 9) is not specified in the address request 915. In short, the address request 915 is broadcast in the virtual network site 1-1 (701).

Processing executed when the host computer H15 (742) is introduced to the WAN 720 is described next. This processing can be read as the processing of FIG. 9 by substituting the host computer H11 (722) with the host computer H15 (742), substituting the WAN switch S21 (711) with the WAN switch S23 (713), substituting the virtual network identifier VN1 with VN2, substituting the address conversion rule M2M1 with M2M2, and substituting the MAC address As with a MAC address assigned to the WAN switch S23 (713).

FIG. 10 is a flow chart illustrating the switch address generating processing 911 of the address distributing server C11 (721) according to the second embodiment of this invention.

The switch address generating processing 911 is processing executed by the switch address generating program 874 of the address distributing server C11 (721). After the switch address generating processing 911 is started, the address distributing server C11 (721) extracts from the next MAC address 881-3 of the MAC address generation data 881 a value MACnext to be assigned as the address of the WAN switch S21 (711).

The address distributing server C11 (721) then refers to the packet 921 of the address request 910 to extract the value VN1 stored in the field for the virtual network identifier 921-5. The address distributing server C11 (721) uses the extracted VN1 value to search the address conversion rule table 882, and extracts the value M2M1 from a row that has the value VN1 as the virtual network identifier 882-1.

The address distributing server C11 (721) stores the extracted value M2M1 in the field for the address conversion rule 922-6 of the packet 922, and stores the extracted value MACnext in the field for the MAC address 922-5 of the packet 922. It should be noted that the value MACnext is indicated by “As” in FIG. 9.

The address distributing server C11 (721) also stores a value MACs of the destination address 921-1 of the packet 921 in the field for the source address 922-2 of the packet 922, and stores a value MACr of the source address 921-2 of the packet 921 in the field for the destination address 922-1 of the packet 922. The address distributing server C11 (721) further stores a value indicating that the packet 922 is an address response and a protocol type in the field for the data 922-4 and the field for the protocol type 922-3, respectively.

After storing values in the packet 922, the address distributing server C11 (721) transmits the packet 922 in which the values have been stored to the WAN switch S21 (711) (1011).

Finishing Step 1011, the address distributing server C11 (721) updates the value of the next MAC address 881-3 with a new MACnext value by using values of MACnext, MACmin, and MACmax which are stored as the minimum MAC address 881-1, maximum MAC address 881-2, and next MAC address 881-3 of the MAC address generation data 881 (1012). For instance, 1 is added to the current MACnext value and the result of the addition is stored as the next MAC address 881-3 (1012).

The address distributing server C11 (721) determines whether or not a new MAC address can be generated by determining whether or not the new MACnext value is within the range of values from MACmin to MACmax.

In the second embodiment, MAC addresses are generated sequentially to be assigned to the WAN switch S as described above. However, assigning sequential MAC addresses may be avoided for such purposes as making it difficult for those with malicious intent to figure out the MAC address of their target. For example, pseudo-random numbers may be used to generate MAC addresses. If an appropriate pseudo-random number generating function is selected, most of MAC addresses within the range between MACmin and MACmax can be assigned, instead of wasting many MAC addresses.

The host computer initializing processing 903 may be executed as the need arises, at a time requested by the host computer H that is to be initialized, instead of when the host computer H is newly introduced.

Described next is the switch address generating processing 911 that is executed when the address distributing server C11 (721) receives the address request 910 from the WAN switch S23 (713). The processing that is executed when the address request 910 is received from the WAN switch S23 (713) can be read as the processing of FIG. 9 by substituting the address conversion rule M2M1 with M2M2 and substituting the virtual network identifier VN1 with VN2.

In short, the processing of FIG. 9 is processing executed for any WAN switch S and for any host computer H.

FIGS. 11A, 11B, and 11C are flow charts illustrating processing that is executed by the WAN switch S21 (711) according to the second embodiment of this invention.

FIG. 11A is a flow chart illustrating the switch address setting processing 913 which is executed by each WAN switch S according to the second embodiment of this invention.

The switch address setting processing 913 is processing executed by the switch address generating program 841. After the switch address setting processing 913 is started, the WAN switch S21 (711) extracts the address conversion rule M2M1 from the address conversion rule 922-6 of the packet 922 received from the address distributing server C11 (721).

The WAN switch S21 (711) stores the extracted address conversion rule M2M1 in the memory 821 in association with the network identifier VN1 (1111). Specifically, the extracted address conversion rule M2M1 is stored in the address conversion rule table 831 included in the data 823.

After Step 1111, the WAN switch S21 (711) extracts the address As (namely, MACnext stored in the packet 922 by the address distributing server C11 (721)) from the MAC address 922-5 of the packet 922. The WAN switch S21 (711) is then connected to the virtual network VN1 (namely, the virtual network site 1-1 (701)). The extracted address As is stored as the MAC address 803 in the NIF 801 of the WAN switch S21 (711) (1112).

Described next is the switch address setting processing 913 that is executed when the WAN switch S23 (713) receives the address response 912. The processing that is executed when the WAN switch S23 (713) receives the address response 912 can be read as the processing of FIG. 11A by substituting the address conversion rule M2M1 with M2M2 and substituting the virtual network VN1 with VN2.

FIG. 11B is a flow chart illustrating the host address generation preparing processing 914 which is executed by each WAN switch S according to the second embodiment of this invention.

The host address generation preparing processing 914 is processing executed by the host address generation preparing program 842 of the WAN switch S21 (711).

After the host address generation preparing processing 914 is started, the WAN switch S21 (711) generates the function M2M1r from the address conversion rule M2M1 extracted in the switch address setting processing 913. The generated function M2M1r is stored as a part of the address conversion rule 831-2 of the address conversion rule table 831, which is held in the memory 823.

The address conversion rule M2M1 is a many-to-one function for calculating the MAC address As of the WAN switch S that is associated with the MAC address MACh of the relevant host computer H, namely, a function for calculating the MAC address of one WAN switch S from MAC addresses respectively assigned to a plurality of host computers H.

The function M2M1r is a function for generating the MAC address of the relevant host computer from the MAC address of the WAN switch S. The result of the function M2M1r(As) (i.e., a result obtained by substituting As for a variant of the function M2M1r) differs each time the calculation is made, and the MAC address of one host computer H is returned. The address MACh of the host computer H calculated by the function M2M1r satisfies a relation M2M1(MACh)=As. In other words, the MAC address of the WAN switch S is obtained by converting the address MACh of the host computer H with the use of the address conversion rule M2M1.

An example of this function M2M1r is a function that returns the minimum MACh satisfying M2M1(MACh)=As (which means that the result of calculating M2M1 with MACh as a variable equals As) when called up for the first time, and subsequently returns a MACh result incremented by 1 each time the function is called up. Another example is a function that uses pseudo-random numbers to return a MACh value that satisfies M2M1(MACh)=As and differs each time the function is called up.

Described next is the host address generation preparing processing 914 that is executed by the WAN switch S23 (713). The host address generation preparing processing 914 that is executed by the WAN switch S23 (713) can be read as the processing of FIG. 11B by substituting the address conversion rule M2M1 with M2M2 and substituting the function M2M1r with M2M2r.

FIG. 11C is a flow chart illustrating the host address generating processing 916 which is executed by each WAN switch S according to the second embodiment of this invention.

The host address generating processing 916 is processing executed by the host address generating program 843 of the WAN switch S21 (711). The host address generating program 843 includes the function of an address setting proxy. The self-address calculating/setting program 895 held in the host computer H11 (722) stores a MAC address generated by the host address generating program 843 in the NIF 885 of the host computer H11 (722).

After the host address generating processing 916 is started, the WAN switch S21 (711) inputs the MAC address As of the WAN switch S21 (711) in the function M2M1r to generate the MAC address MACh′ of the host computer H. The WAN switch S21 (711) then generates the packet 924 containing the generated host computer address MACh′, and transmits the packet 924 to the host computer H11 (722) (1131).

No matter how many times the functions M2M1r and M2M2r are used, the functions M2M1r and M2M2r do not output the same address twice. All host computers H can therefore be assigned addresses different from one another.

The host address generating processing 916 may be executed by the host computer H11 (722). Specifically, the host computer H11 (722) may execute the host address generating processing 916 by storing the value of the MAC address 922-5 and the function M2M1r, which are contained in the packet 922, in the field for the MAC address 924-5 of the packet 924.

Described next is the host address generating processing 916 that is executed by the WAN switch S23 (713). The host address generating processing 916 that is executed by the WAN switch S23 (713) can be read as the processing of FIG. 11C by substituting the function M2M1r with M2M2r.

FIG. 12 is a flow chart illustrating the self-address calculating/setting processing 918 which is executed by the host computer H11 (722) according to the second embodiment of this invention.

The self-address calculating/setting processing 918 is processing executed by the self-address calculating/setting program 895. After the self-address calculating/setting processing 918 is started, the host computer H11 (722) extracts an address MACh′ from the MAC address 924-5 of the packet 917 received from the WAN switch S21 (711), and stores the extracted address MACh′ in the memory 892 (1211).

After Step 1211, the host computer H11 (722) stores the address MACh′ extracted from the received packet 922 as the MAC address 886 in the NIF 885 of the host computer H11 (722) (1212).

Described next is the self-address calculating/setting processing 918 that is executed by the host computer H15 (742). The self-address calculating/setting processing 918 that is executed by the host computer H15 (742) can be read as the processing of FIG. 12 by substituting the host computer H11 (722) with the host computer H15 (742).

Through the processing described above with reference to FIGS. 9 to 12, when a virtual network site is connected to the WAN 720, the host computer H that belongs to the virtual network site is assigned a MAC address unique throughout the WAN.

FIG. 13 is a sequence diagram illustrating communication between the host computers H via the WAN 720 according to the second embodiment of this invention.

The sequence diagram of FIG. 13 illustrates communication between the host computer H11 (722) and the host computer H12 (752), which has been connected to the WAN 720 in advance. For communication from the host computer H11 (722) to the host computer H12 (752), the host computer H11 (722) uses the program 894 to generate an Ethernet packet 1311 and transmits the packet 1311 to the host computer H12 (752).

At the time the packet 1311 is generated, the host computer H11 (722) is already holding the MAC address of the host computer H12 (752).

The WAN switch S21 (711) connected to the host computer H11 (722) receives the Ethernet packet 1311 and then uses the packet converting program 844, which is an address converting proxy, to execute packet converting/transferring processing 1321. The packet converting program 844 executes the packet converting/transferring processing 1321 to attach an Ethernet frame to the head of the Ethernet packet 1311 and to thereby generate an Ethernet packet 1312.

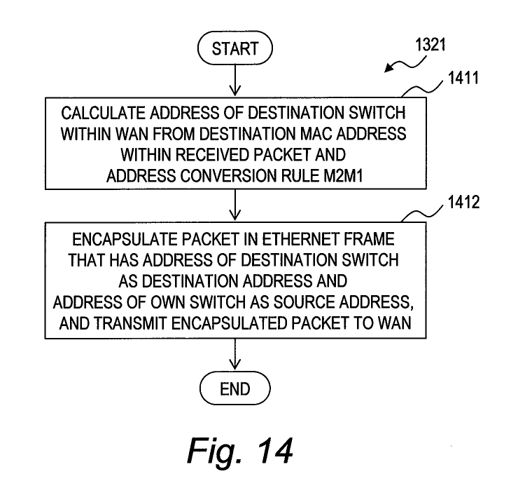

After generating the Ethernet packet 1312, the WAN switch S21 (711) transmits the generated Ethernet packet 1312 to the relevant WAN switch S provided in the WAN 720. The WAN switch S to which the Ethernet packet 1312 is transmitted is the WAN switch S22 (712) connected to the host computer H12 (752). The packet converting/transferring processing 1321 is described later with reference to FIG. 14.

“MAC22” which is the destination address of the packet 1312 indicates the MAC address 803 of the NIF 801 provided in the WAN switch S22 (712). The NIF 801 of the WAN switch S22 (712) is connected to the virtual network site 1-2 (702) and is not connected to any other virtual network site. The packet 1312 is therefore not transferred to other virtual network sites. This also applies to communication between other host computers H.

In other words, according to the second embodiment, communication in the virtual network site VN1 and communication in the virtual network site VN2 do not interfere with each other, and isolation necessary for virtual networks is accomplished.

The WAN switch S22 (712) receives the Ethernet packet 1312 and then uses the packet converting program 844, which is an address converting proxy, to execute the packet converting/transferring processing 1321. The packet converting program 844 executes the packet converting/transferring processing 1321 to remove the Ethernet frame from the head of the Ethernet packet 1312, thereby generating a simple Ethernet packet 1313. The contents of the Ethernet packet 1313 are the same as those of the Ethernet packet 1311.

After generating the Ethernet packet 1313, the WAN switch S22 (712) transmits the generated Ethernet packet 1313 to the host computer H12 (752). The host computer H12 (752) receives the Ethernet packet 1313 and then uses the program 894 to process the Ethernet packet 1313.

For communication from the host computer H12 (752) to the host computer H11 (722), the host computer H12 (752) uses the program 894 to generate an Ethernet packet 1314 and transmits the packet 1314 to the host computer H11 (722).

The WAN switch S22 (712) receives the Ethernet packet 1314 and then uses the packet converting program 844, which is an address converting proxy, to execute the packet converting/transferring processing 1321. The packet converting program 844 executes the packet converting/transferring processing 1321 to attach the Ethernet frame to the head of the Ethernet packet 1314, thereby generating an Ethernet packet 1315.

After generating the Ethernet packet 1315, the WAN switch S22 (712) transmits the generated Ethernet packet 1315 to the relevant WAN switch S of the WAN 720. The WAN switch S to which the Ethernet packet 1315 is transmitted is the WAN switch S21 (711) connected to the host computer H11 (722).

The WAN switch S21 (711) receives the Ethernet packet 1315 and then uses the packet converting program 844, which is an address converting proxy, to execute the packet converting/transferring processing 1321. The packet converting program 844 executes the packet converting/transferring processing 1321 to remove the Ethernet frame from the head of the Ethernet packet 1315, thereby generating a simple Ethernet packet 1316.

After generating the Ethernet packet 1316, the WAN switch S21 (711) transmits the generated Ethernet packet 1316 to the host computer H11 (722). The host computer H11 (722) receives the Ethernet packet 1316 and then uses the program 894 to process the Ethernet packet 1316.

Described next is processing for communication between the host computer H15 (742) and the host computer H17 (762), which has been connected to the WAN 720 in advance. This processing can be read as the processing of FIG. 13 by substituting the host computer H11 (722) with the host computer H15 (742) and substituting the host computer H12 (752) with the host computer H17 (762). The MAC address of the host computer H15 (742) is stored as MAC11 of FIG. 13, the MAC address of the host computer H17 (762) is stored as MAC 12, and the MAC address of the WAN switch S23 (713) is stored as MAC21.

In short, the processing of FIG. 13 is processing executed for communication between the host computers H that belong to the same virtual network.

In communication between the host computer H15 (742) and the host computer H17 (762), the MAC address of the WAN switch S22 (712) stored as MAC22 is the MAC address 803 of the NIF 801 connected to the virtual network site 2-2 (705). In other words, the MAC address 803 of the WAN switch S22 (712) that is used in communication between the host computer H11 (722) and the host computer H12 (752) and the MAC address 803 of the WAN switch S22 (712) that is used in communication between the host computer H15 (742) and the host computer H17 (762) are different addresses.

FIG. 14 is a flow chart illustrating the packet converting/transferring processing 1321 that is executed in communication between the host computer H11 (722) and the host computer H12 (752) according to the second embodiment of this invention.

The packet converting/transferring processing 1321 is processing executed by the packet converting/transferring program 844 of each WAN switch S. Described below is the packet converting/transferring processing 1321 that is executed by the WAN switch S21 (711).

After the packet converting/transferring processing 1321 is started, the WAN switch S21 (711) uses the address conversion rule M2M1 held in the memory 821 to convert the destination MAC address MAC 12 that is contained in the Ethernet packet 1311 received from the host computer H11 (722). The WAN switch S21 (711) thus calculates the MAC address MAC22 of the WAN switch S that is the destination of the Ethernet packet 1311 within the WAN 720 (1411).

The WAN switch S21 (711) may identify the Ethernet packet 1311 as a packet transmitted from the host computer H11 (722) of the virtual network site 1-1 (701) (VN1), based on the source address MAC11 or other data contained in the Ethernet packet 1311.

After Step 1411, the WAN switch S21 (711) encapsulates the Ethernet packet 1311 by attaching, to the head of the Ethernet packet 1311, a field for the Ethernet frame destination address which contains the MAC address MAC22 calculated in Step 1411 and a field for the Ethernet frame source address which contains the MAC address MAC21 of itself (the WAN switch S21 (711)). As a result of the encapsulation, the Ethernet packet 1312 is generated.

The WAN switch S21 (711) transmits the generated packet 1312 to the WAN 720 (1412).

Described next is the packet converting/transferring processing 1321 that is executed by the WAN switch S23 (713) for communication between the host computer H15 (742) and the host computer H17 (762). This processing can be read as the processing of FIG. 14 by substituting the function M2M1r with the function M2M2r.

Each WAN switch S of the second embodiment holds a function that calculates the MAC address of the WAN switch S from the MAC address of the host computer H to which the WAN switch S is connected, and therefore does not need to hold the association relation between the MAC addresses of the host computers H and the MAC addresses of the WAN switches S in advance. In other words, the WAN switches S of the second embodiment do not need to broadcast in advance the association relation between the MAC addresses of the upper host computers H and the MAC addresses of the lower WAN switches S.

According to this embodiment, in a network where communication is held with the use of a packet containing two-layer protocol addresses, there is no need to broadcast the association relation between an upper address and a lower address. Accordingly, an increase in network load due to broadcast and the complication and expansion of protocols, programs, and data for generating broadcast packets are lessened.

While the present invention has been described in detail and pictorially in the accompanying drawings, the present invention is not limited to such detail but covers various obvious modifications and equivalent arrangements, which fall within the purview of the appended claims.

What is claimed is:

1. A network system, comprising:
a plurality of computers; and
a control apparatus coupled to the plurality of computers via a plurality of network apparatuses,
wherein the control apparatus is configured to:
hold a plurality of first addresses and conversion rules for converting each of the plurality of first addresses into a second address;
extract one of the plurality of first addresses and one of the conversion rules when requested by one of the plurality of computers; and
transmit the extracted one of the plurality of first addresses and the extracted one of the conversion rules to the one of the plurality of computers that has issued the request, and
wherein the one of the plurality of computers that has issued the request is configured to:
convert the one of the plurality of first addresses into the second address by using received conversion rule; and
hold the converted second address.

2. The network system according to claim 1,
wherein the plurality of computers include a first computer and a second computer coupled to the first computer,
wherein the first computer is configured to:
convert the one of the plurality of first addresses included in the packet into the second address by using received conversion rule when receiving a packet including one of the plurality of first addresses;
attach the second address to the packet; and
transmit the packet with the second address attached thereto to the second computer which holds the second address, and
wherein the second computer deletes the second address that has been attached to the packet transmitted from the first computer.

3. The network system according to claim 1, wherein each of the plurality of computers transmits a request to the control apparatus when coupled to one of the plurality of network apparatuses.

4. The network system according to claim 1,
wherein the one of the plurality of computers is coupled to at least one virtual network,
wherein the request transmitted to the control apparatus from the one of the plurality of computers includes an identifier indicating the at least one virtual network to which the one of the plurality of computers is coupled, and
wherein the control apparatus is further configured to:
hold the conversion rules associated with the at least one virtual network; and
transmit one of the conversion rules to the one of the plurality of computers that has issued the request based on the identifier of the at least one virtual network that is included in the transmitted request.

5. A network system, comprising:
a plurality of computers; and
a control apparatus coupled to the plurality of computers via a plurality of network apparatuses,
wherein the control apparatus is configured to:
hold a plurality of first addresses and conversion rules for converting a second address into one of the plurality of first addresses;
extract one of the plurality of first addresses and one of the conversion rules when requested by one of the plurality of network apparatuses; and
transmit the extracted one of the plurality of first addresses and the extracted one of the conversion rules to the one of the plurality of network apparatuses that has issued the request,
wherein the one of the plurality of network apparatuses that has issued the request is configured to:
generate a function for converting the one of the plurality of first addresses into the second address based on the transmitted conversion rule;
convert the one of the plurality of first addresses into the second address by using the generated function; and
transmit the second address obtained through the conversion to the one of the plurality of computers, and
wherein the one of the plurality of computers is configured to hold the second address.

6. The network system according to claim 5,
wherein the one of the plurality of network apparatuses that has issued the request holds the transmitted first address,
wherein the plurality of computers include a first computer and a second computer,
wherein the plurality of network apparatuses include a first network apparatus coupled to the first computer and a second network apparatus coupled to the second computer,
wherein the first computer is configured to transmit a packet that includes the second address held by the second computer to the first network apparatus,
wherein the first network apparatus is configured to:
convert the second address that is included in the packet transmitted from the first computer and that is held by the second computer into the first address that is held by the second network apparatus by using the transmitted conversion rule;
attach the first address generated through the conversion to the transmitted packet; and
transmit the packet with the first address attached thereto to the second network apparatus, and
wherein the second network apparatus is configured to:
delete the first address that has been attached to the packet transmitted from the first network apparatus; and
transmit the transmitted packet to the second computer based on the second address of the second computer that is included in the packet transmitted from the first network apparatus.

7. The network system according to claim 5,
wherein the plurality of computers include a third computer and a fourth computer, and
wherein the one of the plurality of network apparatuses that has issued the request is configured to:
couple to the third computer and the fourth computer;
generate a function for converting one of the plurality of first addresses into at least two second addresses by using the transmitted conversion rule;
assign the at least two second addresses which are generated through conversion by the generated function to the third computer and the fourth computer respectively;
transmit the second address that is assigned to the third computer to the third computer; and
transmit the second address that is assigned to the fourth computer to the fourth computer.

8. The network system according to claim 5,
wherein the one of the plurality of network apparatuses that has issued the request is configured to transmit received first address and the generated function to the one of the plurality of computers, and
wherein the one of the plurality of computers is configured to convert the first address into the second address by using received function.

9. The network system according to claim 5,
wherein the one of the plurality of network apparatuses is coupled to at least one virtual network, and
wherein, the one of the plurality of network apparatuses is configured to transmit a request to the control apparatus when an additional virtual network is coupled to the one of the plurality of network apparatuses.

10. The network system according to claim 9,
wherein the request transmitted to the control apparatus from the one of the plurality of network apparatuses includes an identifier indicating the additional virtual network to which the one of the plurality of network apparatuses is coupled, and
wherein the control apparatus is further configured to:
hold the conversion rules associated with the additional virtual network; and
transmit one of the conversion rules to the one of the plurality of network apparatuses based on information of the additional virtual network that is included in the transmitted request.

11. A control apparatus coupled to a plurality of computers via a plurality of network apparatuses,
wherein the control apparatus is configured to:
hold a plurality of first addresses and conversion rules for converting each of the plurality of first addresses into a second address,
extract one of the plurality of first addresses and one of the conversion rules when requested by one of the plurality of computers, and
transmit the extracted one of the plurality of first addresses and the extracted one of the conversion rules to the one of the plurality of computers that has issued the request in order to assign the second address that is generated through the conversion from the extracted one of the plurality of first addresses by the extracted one of the conversion rules to the one of the plurality of computers that has issued the request.

12. The control apparatus according to claim 11,
wherein the one of the plurality of computers is coupled to at least one virtual network,
wherein the request transmitted to the control apparatus from the one of the plurality of computers includes an identifier indicating the at least one virtual network to which the one of the plurality of computers is coupled, and
wherein the control apparatus is configured to:
hold the conversion rules associated with the at least one virtual network; and
transmit one of the conversion rules to the one of the plurality of computers that has issued the request based on the identifier of the at least one virtual network that is included in the transmitted request.

13. A control apparatus coupled to a plurality of computers via a plurality of network apparatuses,
wherein the control apparatus is configured to:
hold a plurality of first addresses and conversion rules for converting a second address into one of the plurality of first addresses,
extract one of the plurality of first addresses and one of the conversion rules when requested by one of the plurality of network apparatuses, and
transmit the extracted one of the plurality of first addresses and the extracted one of the conversion rules to the one of the plurality of network apparatuses that has issued the request in order to assign the extracted one of the plurality of first addresses to the one of the plurality of network apparatuses that has issued the request.

14. The control apparatus according to claim 13,
wherein the one of the plurality of network apparatuses is coupled to at least one virtual network, and
wherein, the one of the plurality of network apparatuses transmits a request to the control apparatus when an additional virtual network is coupled to the one of the plurality of network apparatuses.

15. The control apparatus according to claim 14,
wherein the request transmitted to the control apparatus from the one of the plurality of network apparatuses includes an identifier indicating the at least one virtual network to which the one of the plurality of network apparatuses is coupled, and
wherein the control apparatus is configured to:
hold the conversion rules associated with the at least one virtual network; and
transmit one of the conversion rules to the one of the plurality of network apparatuses based on information of the at least one virtual network that is included in the transmitted request.

16. A network apparatus coupled to a plurality of computers and to a control apparatus,
wherein the control apparatus holds a plurality of first addresses and conversion rules for converting a second address into one of the plurality of first addresses, and
wherein the network apparatus is configured to:
transmit a request to the control apparatus;
receive one of the plurality of first addresses and one of the conversion rules that meet the request and that are transmitted from the control apparatus;
generate a function for converting the one of the plurality of first addresses into the second address based on the received conversion rule;
convert the one of the plurality of first addresses into the second address by using the generated function; and
transmit the second address obtained through the conversion to one of the plurality of computers in order to assign the second address to the one of the plurality of computers.

17. The network apparatus according to claim 16,
wherein the network apparatus holds the transmitted first address,
wherein the plurality of computers include a first computer and a second computer,
wherein the network apparatus is coupled to the first computer and another network apparatus which is coupled to the network apparatus and the second computer,
wherein the network apparatus is further configured to:
receive a packet that includes the second address held by the second computer and that is transmitted from the first computer;
convert the second address that is included in the packet transmitted from the first computer and that is held by the second computer into the first address that is held by the another network apparatus by using the transmitted conversion rule;
attach the first address generated through the conversion to the transmitted packet; and
transmit the packet with the first address attached thereto to the another network apparatus, and
wherein the another network apparatus
deletes the first address that has been attached to the packet transmitted from the first network apparatus, and
transmits the transmitted packet to the second computer based on the second address of the second computer that is contained in the packet transmitted from the network apparatus.

18. The network apparatus according to claim 16,
wherein the plurality of computers include a third computer and a fourth computer, and
wherein the network apparatus is further configured to:
couple to the third computer and the fourth computer;
generate a function for converting one of the plurality of first addresses into at least two second addresses by using the transmitted conversion rule,
assign the at least two second addresses which are generated through conversion by the generated function to the third computer and the fourth computer respectively;
transmit the second address that is assigned to the third computer to the third computer; and
transmit the second address that is assigned to the fourth computer to the fourth computer.

19. The network apparatus according to claim 16, wherein the network apparatus is configured to transmit received first address and the generated function to the one of the plurality of computers in order to assign the second address, which is converted from the first address by the function, to the one of the plurality of computers.

20. The network apparatus according to claim 16,
wherein the network apparatus is coupled to at least one virtual network, and
wherein, the network apparatus is configured to transmit a request to the control apparatus when an additional virtual network is coupled to the network apparatus.
